(19) United States
(12) Patent Application Publication
(10) Pub. No.: US 2025/0170824 A1
(43) Pub. Date: May 29, 2025

(54) IMAGE FORMING METHOD, AND IMAGE FORMING SYSTEM

(71) Applicant: BROTHER KOGYO KABUSHIKI KAISHA, Nagoya (JP)

(72) Inventors: Hiroto SUGAHARA, Ama (JP); Taro NAGANO, Nagoya (JP); Jeongbin LEE, Nagoya (JP); Haru INOUE, Inazawa (JP); Toshiya SAWAKI, Nagoya (JP)

(73) Assignee: BROTHER KOGYO KABUSHIKI KAISHA, Nagoya (JP)

(21) Appl. No.: 18/946,027

(22) Filed: Nov. 13, 2024

(30) Foreign Application Priority Data
Nov. 29, 2023 (JP) 2023-201720

(51) Int. Cl. B41J 2/045

(52) U.S. Cl. CPC B41J 2/04588; B41J 2/04573; B41J 2/04581; B41J 2/04593

(57) ABSTRACT

There is provided an image forming method executed by an image forming system. The method including applying a first driving waveform to a first actuator at a first timing and applying a second driving waveform to the first actuator at a second timing, and/or applying the first driving waveform to the first actuator and applying the second driving waveform to the second actuator at the first timing. The first/second driving waveform is configured so that, in a case where the first/second driving waveform is continuously applied to the actuator at a driving frequency, an ejecting volume of a droplet ejected thirdly from a nozzle is R₁/R₂ times of an ejecting volume of a droplet ejected firstly from the nozzle. R₁ and R₂ are different values from each other.

### REFERENCE TO RELATED APPLICATIONS

This application claims priority from Japanese Patent Application No. 2023-201720 filed on Nov. 29, 2023. The entire content of the priority application is incorporated herein by reference.

### BACKGROUND ART

An image forming method and an image forming system in which an image is formed on a medium moving relative to a head by ejecting droplets from the head, is used. In such an image forming method and image forming system, the head has a plurality of nozzles and a plurality of actuators corresponding respectively to the plurality of nozzles. When voltage is applied to each of the plurality of actuators, a droplet is ejected from the nozzle corresponding to the actuator. The ejected droplet lands on the medium and forms a pixel on the medium.

In such method or system, in order to deal with fluctuations in droplet velocity and droplet volume caused by pressure vibration during droplet ejecting, voltage may be applied to the actuator at a cycle shorter than the specified droplet ejecting cycle and at a cycle longer than the specified droplet ejecting cycle.

### SUMMARY

Here, the following problems exist regarding designing of driving waveform that indicates timing of voltage to be applied to an actuator.

First, in a case where an image forming system performs image forming at a low driving frequency (i.e., in a case where cycle of droplet ejecting is long), the pixels formed by landing of droplets are sparsely located on a medium. In this situation, if the pixels are large, the pixels stand out as grains (i.e., granular quality of the image is enhanced). Therefore, in a case where the image forming system performs image forming at the low driving frequency, making a volume of liquid to be ejected a volume that suppresses the granular quality is desired.

On the other hand, in a case where the image forming system performs image forming at a high driving frequency (i.e., in a case where the cycle of droplet ejecting is short), the pixels formed by the landing of the droplets are densely located on the medium. In this situation, if the pixels are small, the image formed by the densely located pixels will not have sufficient density. Therefore, in a case where the image forming system performs image forming at the high driving frequency, making a volume of liquid to be ejected a volume by which the image has sufficient density is desired.

Here, the relationship between the volume by which granular quality is suppressed and the volume by which the image has sufficient density, in other words, the relationship between the suitable ejecting volume for image forming at the low driving frequency and the suitable ejecting volume for image forming at the high driving frequency, varies depending on configuration of the head and type of a liquid to be ejected from the head. Therefore, the following cases exist. That is, a case where the suitable ejecting volume for image forming at the low driving frequency is smaller than the suitable ejecting volume for image forming at the high driving frequency, a case where the suitable ejecting volume for image forming at the low driving frequency is equal to the suitable ejecting volume for image forming at the high driving frequency, and a case where the suitable ejecting volume for image forming at the low driving frequency is larger than the suitable ejecting volume for image forming at the high driving frequency.

However, in the conventional designing of driving waveforms, in a case where a driving waveform is designed so that the volume of liquid to be ejected is a suitable volume in image forming at the low driving frequency, further designing said driving waveform so that the volume of liquid to be ejected in the image forming at the high driving frequency is also a suitable volume is difficult. Conversely, in a case where a driving waveform is designed so that the volume of liquid to be ejected is a suitable volume in image forming at the high driving frequency, further designing said driving waveform so that the volume of liquid to be ejected in the image forming at the lower driving frequency is also a suitable volume is difficult.

In this regard, the above method or system only adjusts a cycle of applying a driving waveform (i.e., a cycle of applying voltage based on the driving waveform) to deal with the influence of pressure vibration during droplet ejecting, and is not concerned with designing of a driving waveform to achieve both of a suitable ejecting volume for image forming at a low driving frequency and a suitable ejecting volume for image forming at a high driving frequency.

In view of the above, an object of the present disclosure is to provide an image forming method and an image forming system capable of performing image forming by ejecting a suitable volume of a liquid in a case where an ejecting of the liquid is performed at a driving frequency, and is also capable of making an ejecting volume of the liquid a suitable volume in a case where the ejecting of the liquid is performed at a driving frequency different from said driving frequency.

According to a first aspect of the present disclosure there is provided an image forming method executed by an image forming system,
the image forming system including:
a head having a nozzle and an actuator configured to cause the nozzle to eject a liquid; and
a controller configured to control driving of the head, wherein:
the image forming system is configured to form an image on a medium by ejecting the liquid from the head in a state that one of the head and the medium is moved in a moving direction relative to other of the head and the medium;
the nozzle includes a first nozzle and a second nozzle adjacent to each other in an orthogonal direction orthogonal to the moving direction; and
the actuator includes a first actuator configured to cause the first nozzle to eject the liquid and a second actuator configured to cause the second nozzle to eject the liquid,
the method including:
forming a plurality of pixels having tone values same as each other on the medium by continuously applying a first driving waveform and/or a second driving waveform to each of the first actuator and the second actuator at a driving frequency by the controller; and
in the forming of the plurality of pixels, applying the first driving waveform to the first actuator at the first timing and applying the second driving waveform to the first actuator at a second timing after one cycle of the driving frequency from the first timing by the controller, and/or applying the first driving waveform to the first actuator at the first timing and applying the second driving waveform to the second actuator at the first timing, wherein:
the first driving waveform is configured so that, in a case where the first driving waveform is continuously applied to the actuator at the driving frequency, an ejecting volume of a droplet ejected thirdly from the nozzle is R₁ times of an ejecting volume of a droplet ejected firstly from the nozzle;
the second driving waveform is configured so that, in a case where the second driving waveform is continuously applied to the actuator at the driving frequency, an ejecting volume of a droplet ejected thirdly from the nozzle is R₂ times of an ejecting volume of a droplet ejected firstly from the nozzle; and
R₁ and R₂ are different values from each other.

According to a second aspect of the present disclosure, there is provided an image forming system including:
a head having a nozzle and an actuator configured to cause the nozzle to eject a liquid; and
a controller configured to control driving of the head, wherein:
the image forming system is configured to form an image on a medium by ejecting the liquid from the head in a state that one of the head and the medium is moved in a moving direction relative to other of the head and the medium;
the nozzle includes a first nozzle and a second nozzle adjacent to each other in an orthogonal direction orthogonal to the moving direction;
the actuator includes a first actuator configured to cause the first nozzle to eject the liquid and a second actuator configured to cause the second nozzle to eject the liquid;
the controller is configured to execute:
forming a plurality of pixels having tone values same as each other on the medium by continuously applying a first driving waveform and/or a second driving waveform to each of the first actuator and the second actuator at a driving frequency; and
in the forming of the plurality of pixels, applying the first driving waveform to the first actuator at the first timing and applying the second driving waveform to the first actuator at a second timing after one cycle of the driving frequency from the first timing, and/or applying the first driving waveform to the first actuator at the first timing and applying the second driving waveform to the second actuator at the first timing;
the first driving waveform is configured so that, in a case where the first driving waveform is continuously applied to the actuator at the driving frequency, an ejecting volume of a droplet ejected thirdly from the nozzle is R₁ times of an ejecting volume of a droplet ejected firstly from the nozzle;
the second driving waveform is configured so that, in a case where the second driving waveform is continuously applied to the actuator at the driving frequency, an ejecting volume of a droplet ejected thirdly from the nozzle is R₂ times of an ejecting volume of a droplet ejected firstly from the nozzle; and
R₁ and R₂ are different values from each other.

According to the image forming method and the image forming system of the present disclosure, a user of the image forming method and the image forming system can perform image forming by ejecting a suitable volume of a liquid in a case where an ejecting of the liquid is performed at a driving frequency, and can make an ejecting volume of the liquid a suitable volume in a case where the ejecting of the liquid is performed at a driving frequency different from said driving frequency.

### BRIEF DESCRIPTION OF DRAWINGS

FIG. 1 is a schematic configuration diagram of a printer.

FIG. 2 is a plan view of a head system.

FIG. 3 is a plan view of a head.

FIG. 4 is a cross-sectional view along the IV-IV line of FIG. 3.

FIG. 5 is a block diagram depicting an electrical configuration of the printer.

FIG. 6 is an explanatory view depicting a situation in which pixels are formed in matrix by a plurality of nozzles.

FIG. 7 is a graph depicting a waveform of a driving signal configured to alternately apply an increasing driving waveform and a decreasing driving waveform to an actuator at a driving frequency of 63 kHz.

FIG. 8 is a graph depicting a waveform of a driving signal configured to alternately apply an increasing driving waveform and a decreasing driving waveform to an actuator at a driving frequency of 31.5 kHz.

The solid line in FIG. 9A is a graph depicting a waveform of a driving signal configured to continuously apply an increasing driving waveform to an actuator at a driving frequency of 63 kHz. The dotted line in FIG. 9A is a graph depicting a variation of a pressure in the pressure chamber corresponding to the actuator, in a case where the increasing driving waveform depicted by the solid line in FIG. 9A is applied to the actuator. The solid line in FIG. 9B is a graph depicting a waveform of a driving signal configured to continuously apply a decreasing driving waveform to an actuator at a driving frequency of 63 kHz. The dotted line in FIG. 9B is a graph depicting a variation of a pressure in the pressure chamber corresponding to the actuator in a case where the decreasing driving waveform depicted by the solid line in FIG. 9B is applied to the actuator.

FIG. 10A is a graph depicting a variation in a volume of an ink droplet ejected from a nozzle corresponding to an actuator in a case where the increasing driving waveform is continuously applied to the actuator. FIG. 10B is a graph depicting a variation in a volume of an ink droplet ejected from a nozzle corresponding to an actuator in a case where the decreasing driving waveform is continuously applied to the actuator.

Each of FIG. 11A and FIG. 11B is a plan view depicting a situation of pixels formed on a medium in a case where the increasing driving waveform and the decreasing driving waveform are applied to the plurality of nozzles alternately nozzle by nozzle and timing by timing. FIG. 11A depicts a situation in which the application is performed at the high driving frequency. FIG. 11B depicts a situation in which the application is performed at the low driving frequency.

FIG. 12A is a table summarizing types of driving waveforms used to eject ink droplets and volumes of the ejected ink droplets regarding the ejecting of the ink droplets for forming each pixel depicted in FIG. 11A. FIG. 12B is a table summarizing types of driving waveforms used to eject ink droplets and volumes of the ejected ink droplets regarding the ejecting of the ink droplets for forming each pixel depicted in FIG. 11B.

FIG. 13 is a plan view depicting a situation of pixels formed on a medium in a case where the increasing driving waveform and the decreasing driving waveform are applied to a plurality of nozzles alternately timing by timing.

Each of FIG. 14A and FIG. 14B is a table summarizing types of driving waveforms used for ejecting ink droplets and volumes of the ejected ink droplets regarding a case where pixels are formed by applying the increasing driving waveform and the decreasing driving waveform to a plurality of nozzles alternately timing by timing. FIG. 14A shows the values in a case where the application is performed at the high driving frequency, and FIG. 14B shows the values in a case where the application is performed at the low driving frequency.

FIG. 15 is a plan view depicting a situation of pixels formed on a medium in a case where the increasing driving waveform and the decreasing driving waveform are applied to a plurality of nozzles alternately nozzle by nozzle.

Each of FIG. 16A and FIG. 16B is a table summarizing types of driving waveforms used for ejecting ink droplets and volumes of the ejected ink droplets regarding a case where pixels are formed by applying the increasing driving waveform and the decreasing driving waveform to a plurality of nozzles alternately nozzle by nozzle. FIG. 16A shows the values in a case where the application is performed at the high driving frequency, and FIG. 16B shows the values in a case where the application is performed at the low driving frequency.

FIG. 17 is a graph depicting a variation in a volume of an ink droplet ejected from a nozzle corresponding to an actuator in a case where the increasing driving waveform is continuously applied to the actuator.

FIG. 18 is a plan view depicting a situation of pixels formed on a medium in a case where two types of increasing driving waveforms are applied to a plurality of nozzles alternately nozzle by nozzle and timing by timing.

FIG. 19 is a table summarizing types of driving waveforms used for ejecting ink droplets and volumes of the ejected ink droplets regarding the ejecting of the ink droplets for forming each pixel depicted in FIG. 18.

FIG. 20 is a graph depicting a variation in a volume of an ink droplet ejected from a nozzle corresponding to an actuator in a case where the decreasing driving waveform is continuously applied to the actuator.

FIG. 21 is a plan view depicting a situation of pixels formed on a medium in a case where two types of decreasing driving waveforms are applied to a plurality of nozzles alternately nozzle by nozzle and timing by timing.

FIG. 22 is a table summarizing types of driving waveforms used for ejecting ink droplets and volumes of the ejected ink droplets regarding the ejecting of the ink droplets for forming each pixel depicted in FIG. 21.

Each of FIG. 23A and FIG. 23B is a graph depicting a variation in a volume of an ink droplet ejected from a nozzle corresponding to an actuator in a case where the increasing driving waveform is continuously applied to the actuator.

FIG. 24 is a plan view depicting a situation of pixels formed on a medium in a case where two types of increasing driving waveforms and one type of decreasing driving waveform are applied to a plurality of nozzles alternately timing by timing.

### DESCRIPTION

### Embodiment

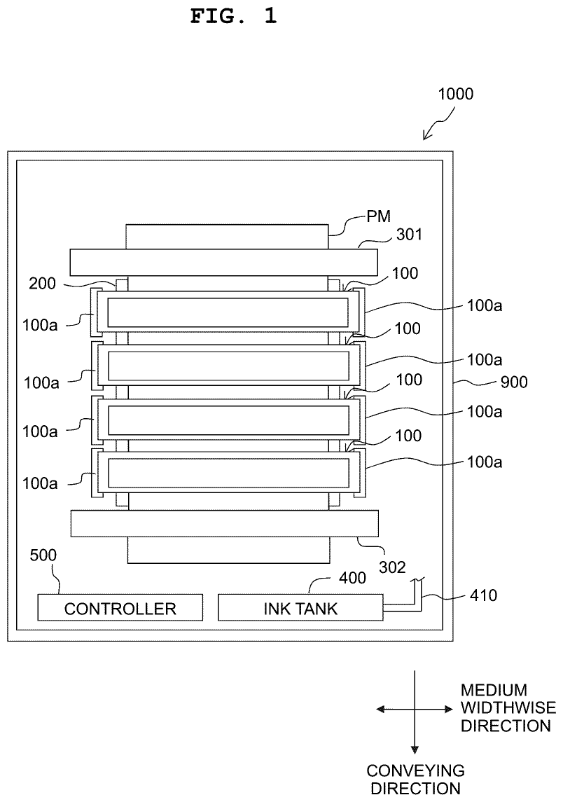

A printer (image forming system) 1000 as an embodiment of the disclosure, and an image forming method using the printer 1000 are described with reference to FIG. 1 to FIG. 12.

### Printer 1000

As depicted in FIG. 1, the printer 1000 mainly includes four head systems 100, a platen 200, a pair of conveying rollers 301 and 302, an ink-tank 400, a controller 500, and a housing 900 that houses those components.

In the following description, the direction in which the pair of conveying rollers 301 and 302 is arranged side by side, i.e., the direction in which a medium PM is conveyed during image forming, is referred to as a conveying direction. The direction that extends in the horizontal plane and is orthogonal to the conveying direction is referred to as a medium widthwise direction. The conveying direction is an example of a “moving direction”, and the medium widthwise direction is an example of an “orthogonal direction”.

Each of the four head systems 100 is a so-called line-type head (a head bar). Each of the four head systems 100 is supported by a frame 100a at both ends in the medium widthwise direction.

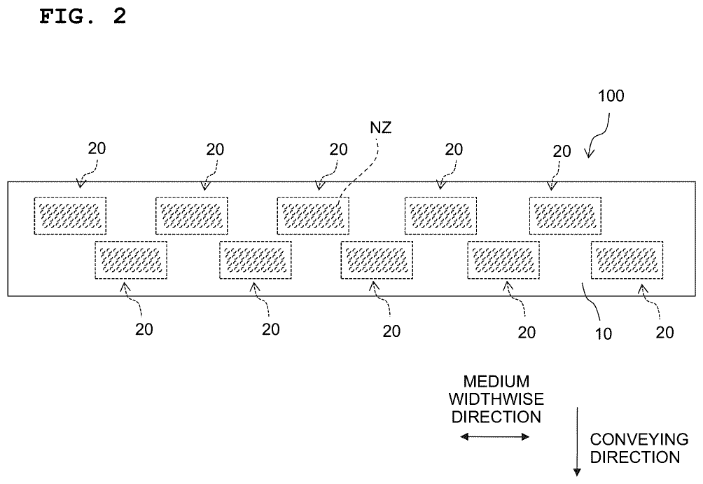

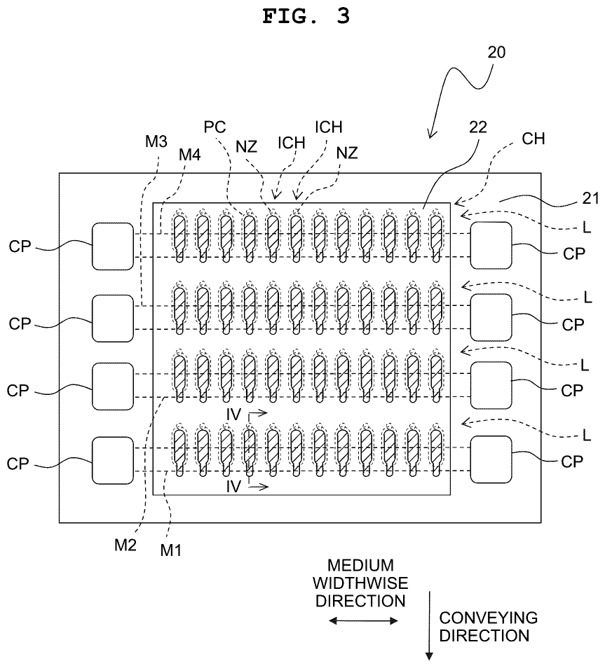

As depicted in FIG. 2, each of the four head systems 100 includes a rectangular plate-shaped holding member 10 and ten heads 20 held by the holding member 10. Both ends in the longitudinal direction of the holding member 10 are supported by the frame 100a. The ten heads 20 are disposed in a staggered pattern along the medium widthwise direction.

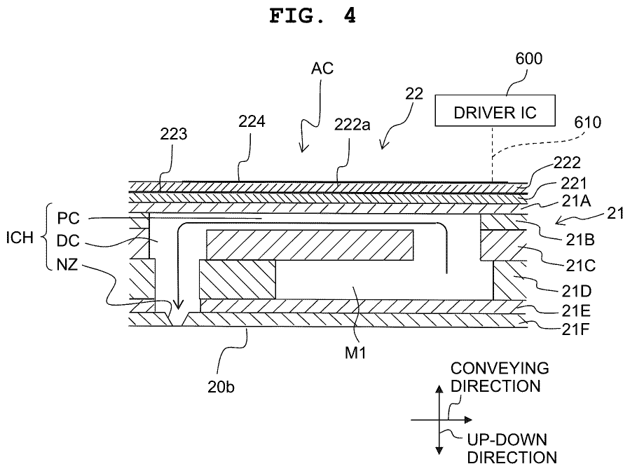

Each of the ten heads 20 mainly includes a channel unit 21 and an actuator unit 22, as depicted in FIG. 3 and FIG. 4.

As depicted in FIG. 4, the channel unit 21 is a laminated structure including an ink sealing film 21A, plates 21B to 21E, and a nozzle plate 21F stacked in this order from the top. Inside the channel unit 21, a channel CH (FIG. 3) is formed by removing a portion of each of the plates 21B to 21E and the nozzle plate 21F.

As depicted in FIG. 3 and FIG. 4, the channel CH includes eight ink communication ports CP; four manifold channels M1, M2, M3, and M4; and forty-eight individual channels ICH. Four of the eight ink communication ports CP are provided at each end of the channel unit 21 in the medium width direction. The manifold channels M1 to M4 each extend in the medium widthwise direction and connect the ink communication port CP at one end with the ink communication port CP at the other end in the medium widthwise direction. To each of the manifold channels M1 to M4, twelve individual channels ICH are connected along the medium widthwise direction.

Each of the forty-eight individual channels ICH includes a pressure chamber PC, a descender channel DC, and a nozzle NZ, as depicted in FIG. 4.

The pressure chamber PC is a space for applying pressure to the ink by the actuator unit 22 and is formed by removing a part of the plate 21B. The upper surface of the pressure chamber PC is formed by the ink sealing film 21A. One end of the pressure chamber PC is connected to one of the manifold channels M1 to M4.

The descender channel DC is a channel through which the ink in the pressure chamber PC flows to the nozzle NZ, and is formed by coaxially providing circular through holes in the plates 21C to 21E, respectively. The descender channel DC extends from the pressure chamber PC to the nozzle NZ in the up-down direction.

The nozzle NZ is a micro opening configured to eject the ink toward the medium PM, and is formed in the nozzle plate 21F. On the lower surface of the nozzle plate 21F (i.e., a lower surface 20b of the head 20), four nozzle rows L (FIG. 3) are formed by forty-eight nozzles NZ. Each of the four nozzle rows L contains twelve nozzles NZ aligned in the medium widthwise direction. The four nozzle rows L are arranged in the conveying direction. The positions in the medium widthwise direction of the twelve nozzles NZ included in each of the nozzle rows L are different among the nozzle rows L. That is, the head 20 has forty-eight nozzles NZ that are dispersed to four rows and having positions in the medium widthwise direction different from each other.

As depicted in FIG. 4, the actuator unit 22 includes a first piezoelectric layer 221 disposed on the upper surface of the channel unit 21, a second piezoelectric layer 222 above the first piezoelectric layer 221, a common electrode 223 sandwiched between the first piezoelectric layer 221 and the second piezoelectric layer 222, and a plurality of individual electrodes 224 disposed on the upper surface of the second piezoelectric layer 222.

The first piezoelectric layer 221 is disposed on the upper surface of the ink sealing film 21A so as to cover all of the plurality of individual channels ICH formed in the channel unit 21. On the upper surface of the first piezoelectric layer 221, a common electrode 223 is provided covering almost the entire upper surface of the first piezoelectric layer 221, and on the upper surface of the common electrode 223, a second piezoelectric layer 222 is disposed covering the entire area of the first piezoelectric layer 221 and the common electrode 223.

The common electrode 223 is grounded via a wiring (not depicted) and is always maintained at ground potential.

Each of the plurality of individual electrodes 224 has a substantially rectangular planar shape with the conveying direction as the longitudinal direction. The plurality of individual electrodes 224 is disposed on the upper surface of the second piezoelectric layer 222 so that the plurality of individual electrodes 224 is positioned above the plurality of pressure chambers PC of the plurality of individual channels ICH, respectively. Each of the plurality of individual electrodes 224 is aligned to be positioned above the center of the corresponding pressure chamber PC.

One actuator (driving element) AC is constructed of one individual electrode 224, a portion of the first piezoelectric layer 221, a portion of the second piezoelectric layer 222, and a portion of the common electrode 223, which are located below said individual electrode 224. One actuator AC is configured for each of a number of individual channels ICH. That is, one actuator AC is configured corresponding to each of a number of pressure chambers PC and a number of nozzles NZ.

In each actuator AC, the portion of the second piezoelectric layer 222 sandwiched between the common electrode 223 and the individual electrode 224 is an active portion 222a polarized in the thickness direction.

The individual electrode 224 of each actuator AC is connected to the driver IC 600 via a flexible circuit board 610.

The platen 200 is a plate-like member that supports the medium PM from a side opposite to a side at which the head system 100 is disposed (that is from a position below the medium PM), in a case where the ink is ejected from the nozzles NZ of the head system 100 to the medium PM.

The pair of conveying rollers 301, 302 are positioned across the platen 200 in the conveying direction. The pair of conveying rollers 301 and 302 conveys the medium PM in the conveying direction in a predetermined manner, in a case where the head system 100 forms an image on the medium PM.

The ink tank 400 is divided into four sections to accommodate inks of four colors. The inks of four colors are sent to a reservoir (not depicted) by a conduit 410. The reservoir is also divided into four sections to accommodate the inks of four colors. The ink of each color sent to the reservoir is circulated between one of the four head systems 100 and the reservoir via undepicted conduit and pump.

Specifically, an ink sent from the reservoir to the head system 100 is supplied to the ink communication port CP on the one end in the medium widthwise direction of the head 20. The ink that has not been ejected from the nozzles NZ is discharged from the ink communication port CP on the other end in the medium widthwise direction of the head 20, and is returned to the reservoir.

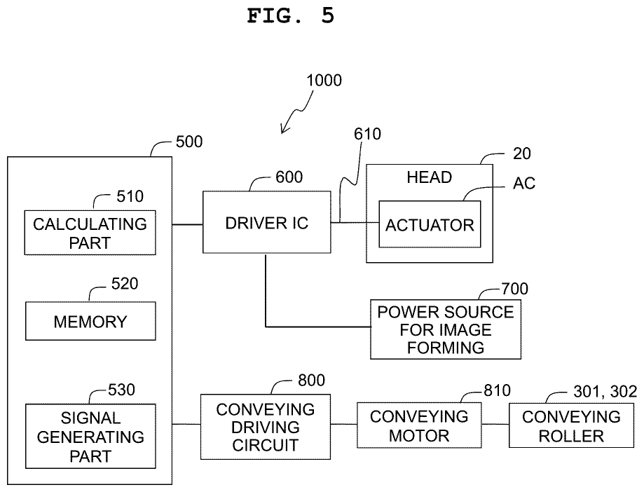

The controller 500 includes a calculating part 510, a memory 520, and a signal generating part 530, as depicted in FIG. 5.

The calculating part 510 performs various calculations necessary to control the printer 1000, and the memory 520 stores various data used in the printer 1000. The calculating part 510 is constructed, for example, of a processor such as a CPU, an integrated circuit such as an ASIC, an FPGA (Field Programmable Gate Array), or the like. The memory 520 is constructed of, for example, a RAM, a ROM, or the like.

The signal generating part 530 generates a driving signal that indicates timing of driving of the actuator AC of the head 20. In this embodiment, the driving signal is a waveform signal including a pulse-shaped driving waveform (details will be described below). The signal generating part 530 may be a dedicated circuit or may be constructed of the calculating part 510 and the memory 520.

The controller 500 is connected to each actuator AC of each head 20 via the driver IC 600 and the flexible circuit board 610. A power source for image forming 700 is connected to the driver IC 600. The driver IC 600 is also connected (grounded) to the ground via undepicted wiring. One driver IC 600 and one power source for image forming 700 are provided for each head 20.

The driver IC 600 applies driving voltage to the individual electrode 224 of each actuator AC of each head 20 by using the power source for image forming 700. The driver IC 600 also imparts a ground potential to the individual electrode 224 of each actuator AC of each head 20 by using a connection to the ground.

The power source for image forming 700 is a power source circuit for applying the driving voltage to the actuator AC. The power source for image forming 700 can be, for example, a DC/DC converter constructed of a plurality of electronic components such as FETs, inductors, resistors, and electrolytic capacitors, and the like.

The controller 500 is also connected to the conveying driving circuit 800 and the conveying motor 810. The controller 500 drives the conveying rollers 301 and 302 by controlling the conveying motor 810.

### Image Forming Method

Image forming on the medium PM by using the printer 1000 is performed as follows.

First, the controller 500 obtains image data (e.g., raster data) indicating an image to be formed on the medium PM, from an external device (not depicted. a PC, for example). Based on the image data, the signal generating part 530 of the controller 500 generates a driving signal DS for each actuator AC of each head 20, the driving signal DS indicating driving timing of the actuator AC. The controller 500 sends the generated driving signal DS to the driver IC 600.

Based on the driving signals DS received from the controller 500, the driver IC 600 applies the driving voltage to the individual electrode 224 of each actuator AC at the timing indicated by the driving signal DS. In this situation, the driver IC 600 connects each actuator AC to the power source for image forming 700 and applies the driving voltage by using the power source for image forming 700. As a result, the ink sealing film 21A above the pressure chamber PC vibrates, pressure is applied to the ink in the pressure chamber PC, and an ink droplet is ejected from the nozzle NZ communicating with the pressure chamber PC via the descender channel DC. Details of the driving signal DS generated by the signal generating part 530 and the ejecting of the ink droplet from the nozzle NZ based on the driving signal DS are described later.

Meanwhile, the controller 500 drives the conveying motor 810 via the conveying driving circuit 800 based on the image data obtained from the external device.

In such a manner, the controller 500 alternately or in parallel executes a recording operation in which each actuator AC of each head 20 is driven to eject the ink from each nozzle NZ onto the medium PM and a conveying operation in which the conveying rollers 301 and 302 are rotated via the conveying motor 810 to convey the medium PM in the conveying direction. By doing so, the controller 500 forms the image indicated by the image data on the medium PM, while moving the head 20 and the medium PM relative to each other in the conveying direction.

### Driving Signal DS, and Ejecting Based on Driving Signal DS

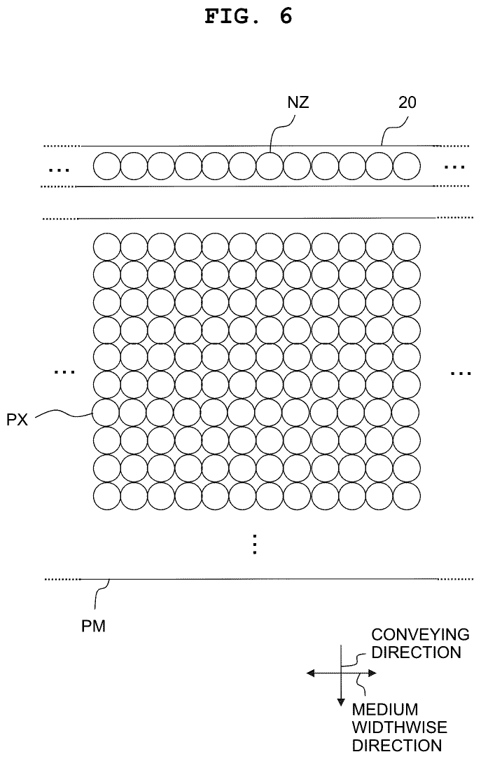

The driving signal DS generated by the signal generating part 530 and the ejecting of the ink droplets from the nozzles NZ based on the driving signals DS are described referring to the case of continuously forming pixels PX (FIG. 6) of the same tone value on the medium PM as an example.

Here, the controller 500 is assumed to eject the ink droplets from the plurality of nozzles NZ (FIG. 6) arranged in the medium widthwise direction to form a matrix of pixels PX of the same tone value on the medium PM moving in the conveying direction. This type of printing is so-called solid printing as an example. In FIG. 6, a plurality of nozzles NZ in a row are depicted to simplify the illustration, but as described above, the nozzles NZ of the head 20 are dispersed to four rows. The feature of “a first nozzle and a second nozzle adjacent to each other in an orthogonal direction orthogonal to a moving direction” means the two nozzles closest to each other in the orthogonal direction, regardless of whether they are in the same position in the moving direction or they are in different positions in the moving direction.

The “tone value” is a value indicating the size of the ink droplet ejected from the nozzle NZ (and thus the size of the pixel PX to be formed). The printer 1000 of the embodiment ejects the ink droplet in one of four tone values (i.e., “large,” “medium,” “small,” and “no ejecting”). The tone values may be other than four steps, for example, eight steps.

The printer 1000 of the embodiment can selectively perform printing at a high driving frequency and printing at a low driving frequency. In other words, the printer 1000 of the embodiment can selectively perform ejecting of the ink droplets from the nozzles NZ in a short driving cycle to form pixels PX densely on the medium PM and ejecting of the ink droplets from the nozzles NZ in a long driving cycle to form pixels PX sparsely on the medium PM. The high driving frequency is 63 kHz as an example, and the low driving frequency is 31.5 kHz as an example. As an example, the printer 1000 executes printing at the high driving frequency for high-quality image forming, and executes printing at the low driving frequency for normal-quality image forming. As another example, the printer 1000 executes printing at the high driving frequency in a case where the printer 1000 performs high-speed printing.

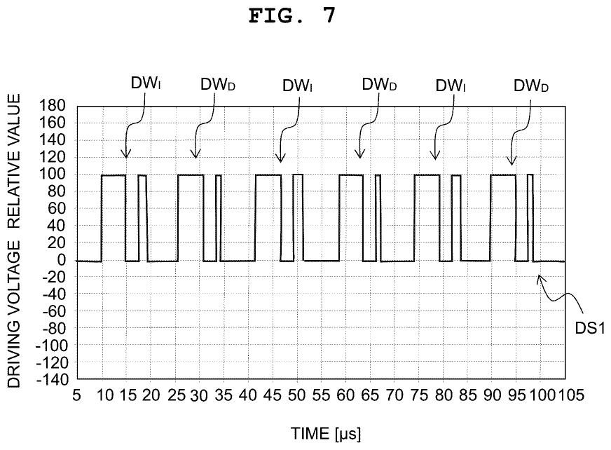

FIG. 7 depicts an example of a driving signal DS1 generated by the signal generating part 530 in a case where the printer 1000 continuously forms the pixels PX of the same tone value at the high driving frequency. As depicted in FIG. 7, the driving signal DS1 alternately includes an increasing driving waveform DW_{I} (details will be described later) and a decreasing driving waveform DW_{D} (details will be described later). In the driving signal DS1, the period from the rising of the increasing driving waveform DW_{I} to the rising of the next decreasing driving waveform DW_{D} is about 16 [μs] (that is, the length of the driving cycle corresponding to the high driving frequency of 63 kHz). The period from the rising of the decreasing driving waveform DW_{D} to the rising of the next increasing driving waveform DW_{I} is also about 16 [μs]. That is, the driving signal DS1 alternately includes the increasing driving waveform DW_{I} and the decreasing driving waveform DW_{D} with a period of about 16 [μs].

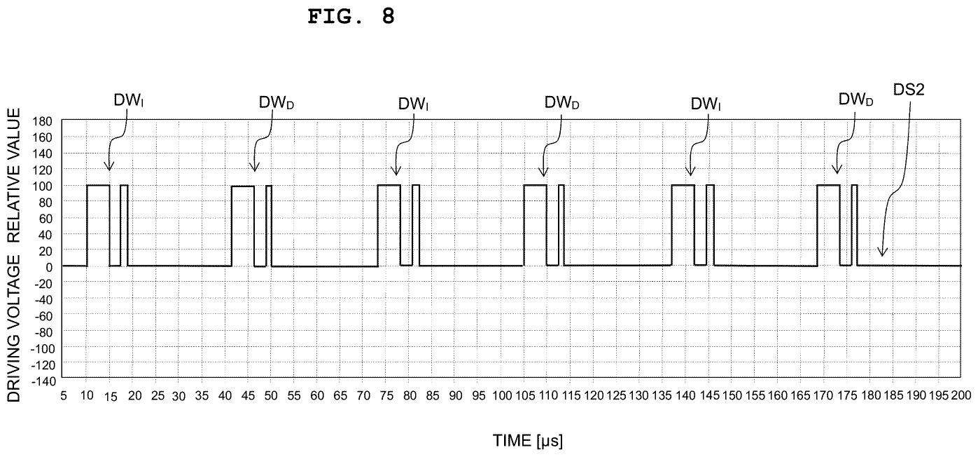

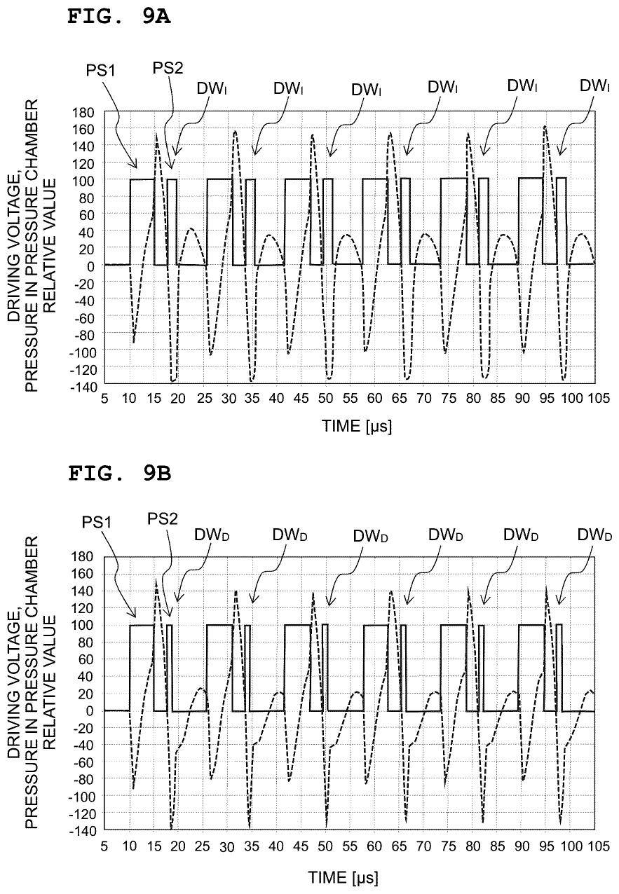

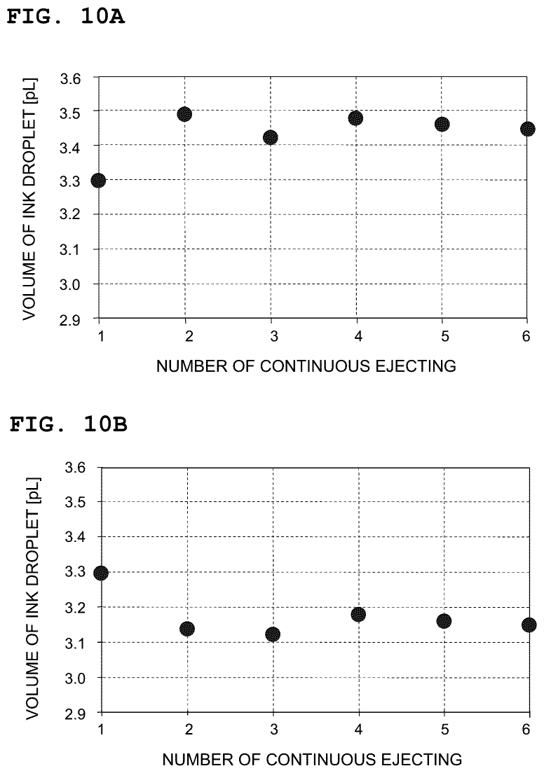

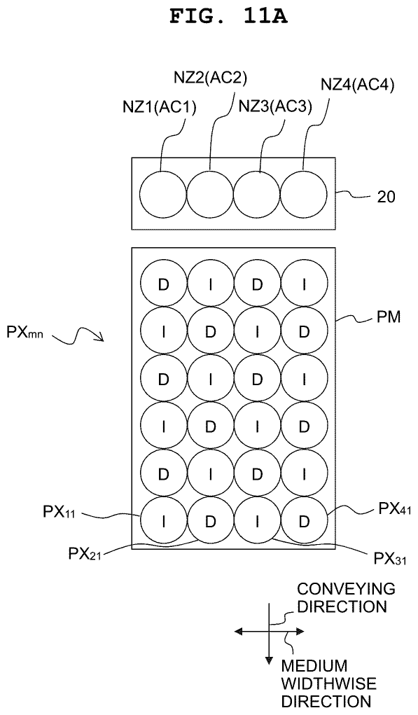

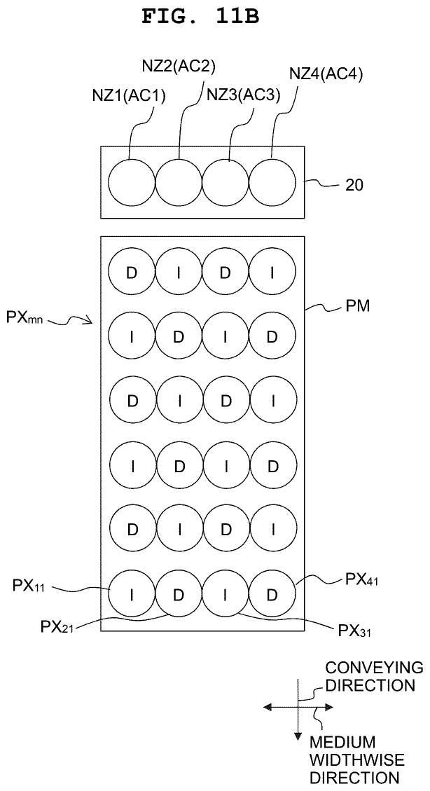

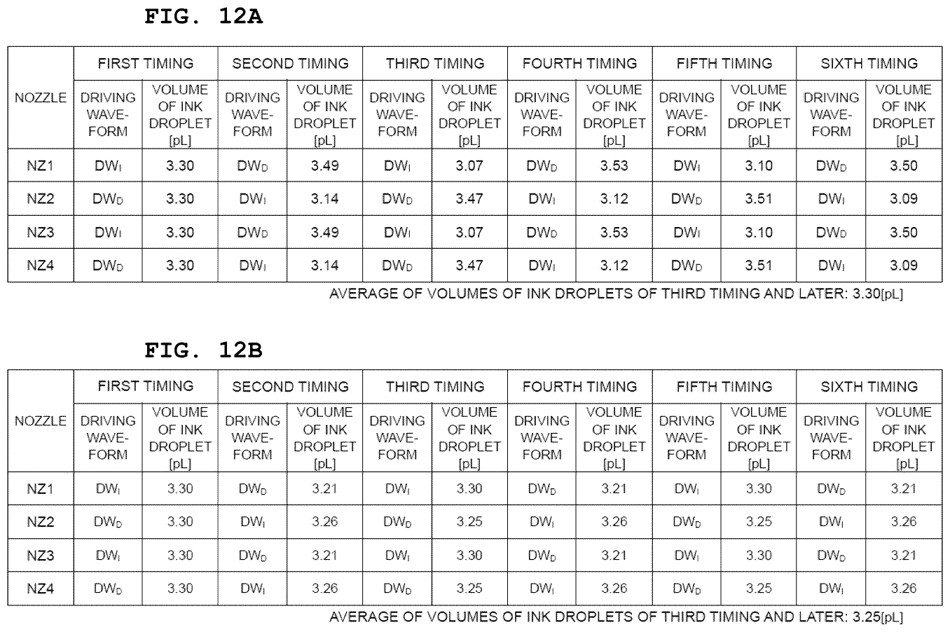

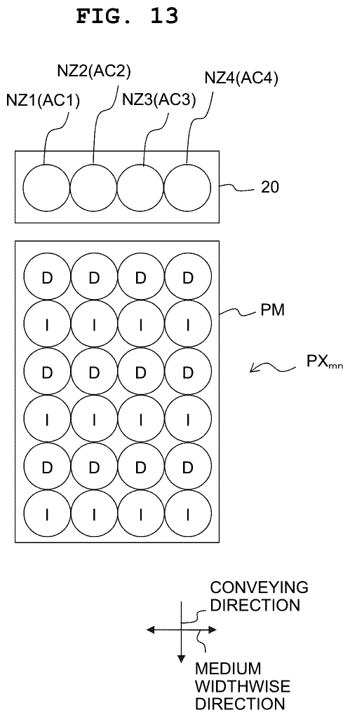

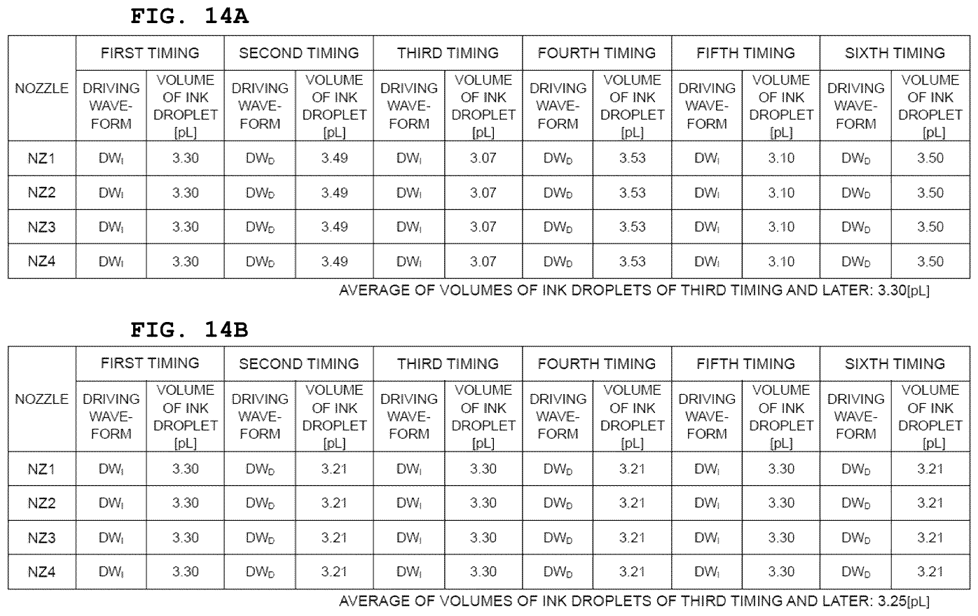

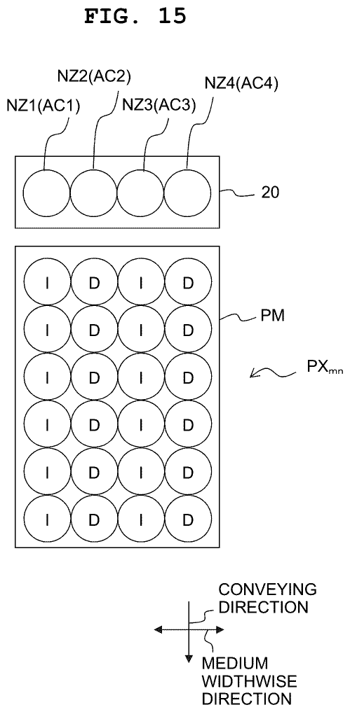

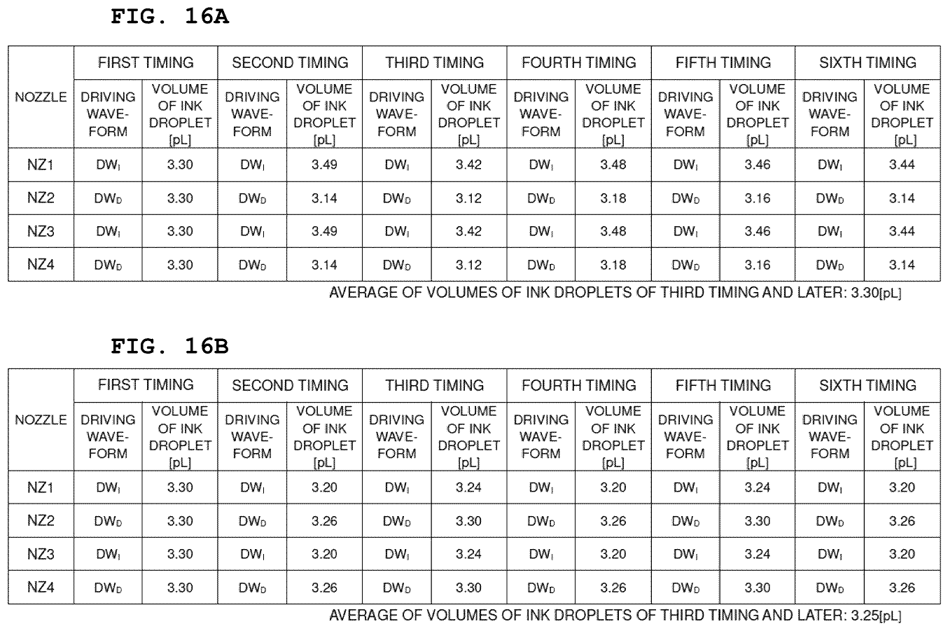

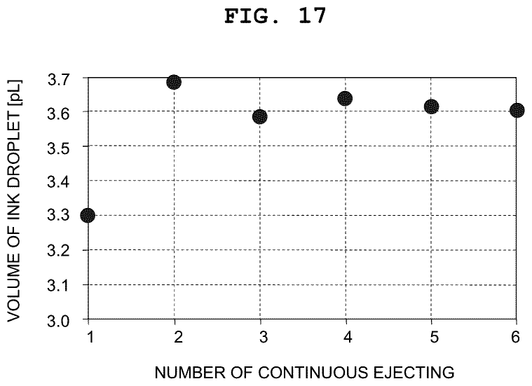

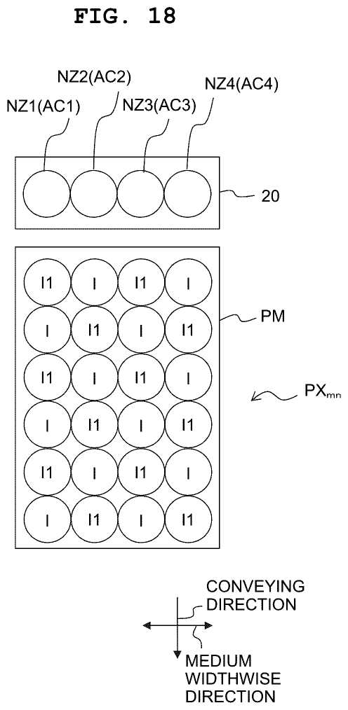

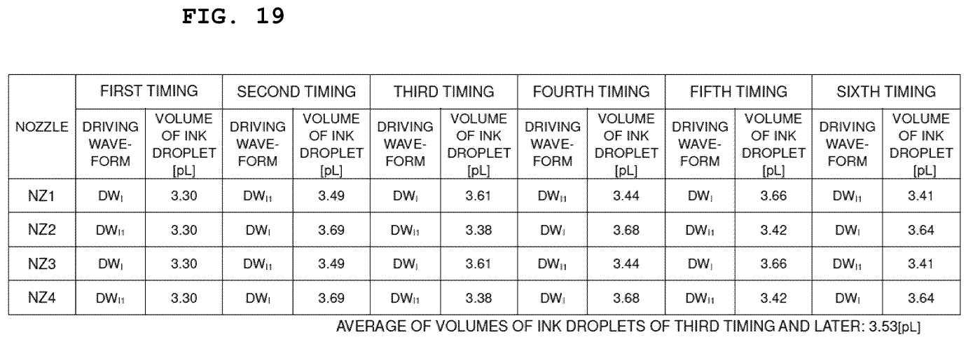

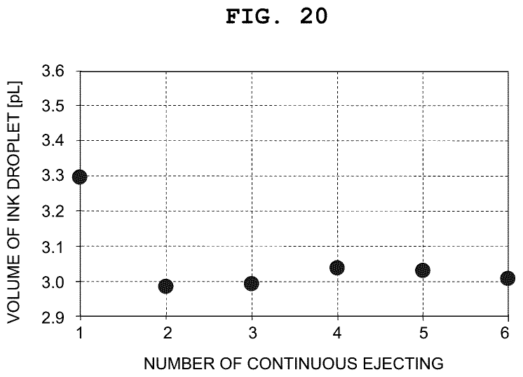

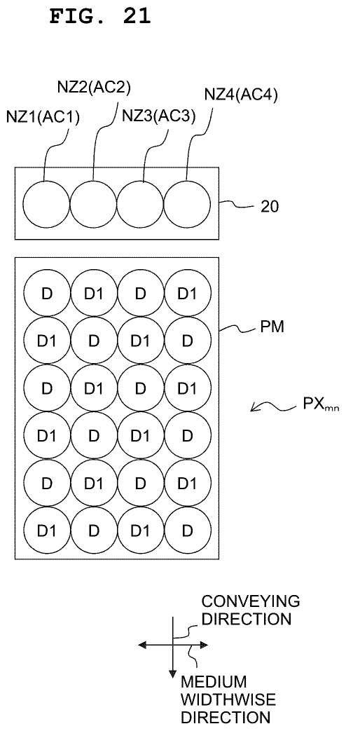

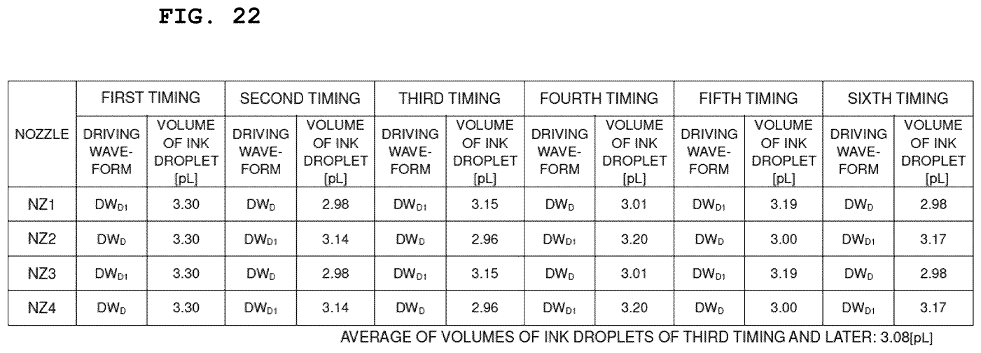

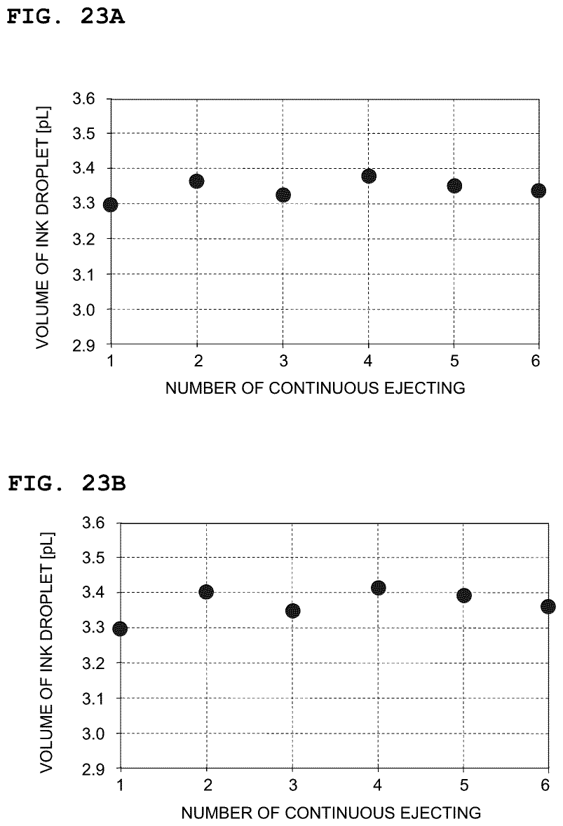

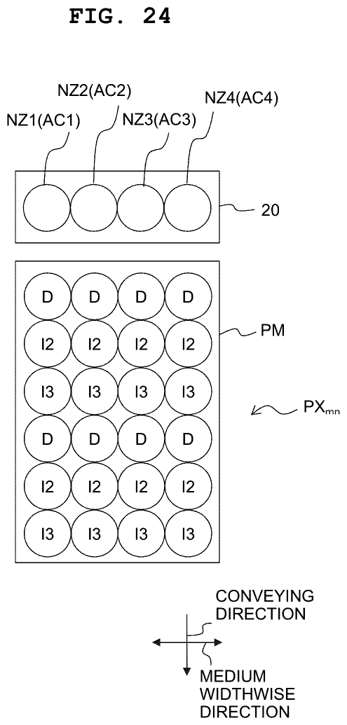

FIG. 8 depicts an example of a driving signal DS2 generated by the signal generating part 530 in a case where the printer 1000 continuously forms the pixels of the same tone value at the low driving frequency. As depicted in FIG. 8, the driving signal DS2 includes the increasing driving waveform DW_{I} and the decreasing driving waveform DW_{D}, alternately. In the driving signal DS2, the period from the rising of the increasing driving waveform DW_{I} to the rising of the next decreasing driving waveform DW_{D} is about 32 [μs] (that is, the length of the driving cycle corresponding to the low driving frequency of 31.5 kHz). The period from the rising of the decreasing driving waveform DW_{D} to the rising of the next increasing driving waveform DW_{I} is also about 32 [μs]. That is, the driving signal DS2 includes the increasing driving waveform DW_{I} and the decreasing driving waveform DW_{D} alternately with a period of about 32 [μs].

The increasing driving waveform DW_{I} is a driving waveform configured so that, in a case where the ink droplets are ejected from the nozzle NZ based on the increasing driving waveform DW_{I} at the high driving frequency (63 kHz in the embodiment), volumes of the ink droplets ejected second or later are larger than a volume of the ink droplet ejected first. Therefore, in a case where the ink droplets are ejected from the nozzle NZ at the high driving frequency (63 kHz in the embodiment), the volume of the ink droplet increases in the ejecting after one cycle of the ejecting by the increasing driving waveform DW_{I}.

As depicted in FIG. 9A, the increasing driving waveform DW_{I} of the embodiment consists of two pulses. A pulse width of a first pulse PS1 is 5.0 [μs] and a pulse width of a second pulse PS2 is 1.8 [μs]. There is an interval of 2.7 [μs] between the first pulse PS1 and the second pulse PS2. During the risen period of the first pulse PS1 and the risen period of the second pulse PS2, the driving voltage of 100% is applied to the actuator AC.

As depicted in FIG. 9A, the case where the increasing driving waveform DW_{I} is applied to the actuator AC with a cycle of about 16 [μs] corresponding to the high driving frequency (63 kHz) to eject the ink droplets from the nozzle NZ corresponding to the actuator AC (Note that the wording of “applying the driving waveform to the actuator” means applying the voltage corresponding to the driving waveform to the actuator) is considered. In this situation, as depicted in FIG. 10A, the volumes of the second and subsequent ink droplets (i.e., the ink droplets of the second and subsequent shots) are larger than the volume of the first ink droplet (i.e., the ink droplet of the first shot). This is because the pressure in the pressure chamber PC fluctuates, as depicted by the dotted line graph in FIG. 9A, due to a residual vibration of the actuator AC caused by the ejecting of the first ink droplet, and when the second and subsequent ink droplets are ejected (specifically, at the timing at which the first pulse PS1 of each of the second and subsequent increasing driving waveforms DW_{I} falls), the pressure in the pressure chamber PC is larger than the designed value.

Regarding the increasing driving waveform DW_{I} of the embodiment, as depicted in FIG. 10A, the volume V1 of the first ink droplet (i.e., the ink droplet ejected firstly) is 3.30 [pL], the volume V2 of the second ink droplet (i.e., the ink droplet ejected secondly) is 3.49 [pL], the volume V3 of the third ink droplet (i.e., the ink droplet ejected thirdly) is 3.42 [pL], the volume V4 of the fourth ink droplet (i.e., the ink droplet ejected fourthly) is 3.48 [pL], the volume V5 of the fifth ink droplet (i.e., the ink droplet ejected fifthly) is 3.46 [pL], the volume V6 of the sixth ink droplet (i.e., the ink droplet ejected sixthly) is 3.44 [pL]. The average value VA of the volumes of the ink droplets from the third shot to the sixth shot is 3.45 [pL]. The ejecting volume ratio R_{I}, which is the ratio of the average value VA to the volume V1, is R_{I}=VA/V1=1.045.

The decreasing driving waveform DW_{D} is a driving waveform configured so that, in a case where the ink droplets are ejected from the nozzle NZ based on the decreasing driving waveform DW_{D} at the high driving frequency (63 kHz in the embodiment), volume of the ink droplets ejected second or later are smaller than a volume of the ink droplet ejected first. Therefore, in a case where the ink droplets are ejected from the nozzle NZ at the high driving frequency (63 kHz in the embodiment), the volume of the ink droplet is reduced in the ejecting after one cycle of the ejecting by the decreasing driving waveform DW_{D}.

As depicted in FIG. 9B, the decreasing driving waveform DW_{D} consists of two pulses. A pulse width of a first pulse PS1 is 5.0 [μs] and a pulse width of a second pulse PS2 is 1.0 [μs]. There is an interval of 2.7 [μs] between the first pulse PS1 and the second pulse PS2. During the risen period of the first pulse PS1 and the risen period of the second pulse PS2, the driving voltage of 100% is applied to the actuator AC.

As depicted in FIG. 9B, the case where the decreasing driving waveform DW_{D} is applied to the actuator AC with a cycle of about 16 [μs] corresponding to the high driving frequency (63 kHz) to eject the ink droplets from the nozzle NZ corresponding to the actuator AC is considered. In this situation, as depicted in FIG. 10B, the volume of the second and subsequent ink droplets (i.e., the ink droplets of the second and subsequent shots) are smaller than the volume of the first ink droplet (i.e., the ink droplet of the first shot). This is because the pressure in the pressure chamber PC fluctuates, as depicted in the dotted line graph in FIG. 9B, due to the residual vibration of the actuator AC caused by the ejecting of the first ink droplet, and when the second and subsequent ink droplets are ejected (specifically, at the timing at which the first pulse PS1 of each of the second and subsequent decreasing driving waveforms DW_{D} falls), the pressure in the pressure chamber PC is smaller than the designed value.

Regarding the decreasing driving waveform DW_{D}, as depicted in FIG. 10B, the volume V1 of the first ink droplet is 3.30 [pL], the volume V2 of the second ink droplet is 3.14 [pL], the volume V3 of the third ink droplet is 3.12 [pL], the volume V4 of the fourth ink droplet is 3.18 [pL], the volume V5 of the fifth ink droplet is 3.16 [pL], the volume V6 of the sixth ink droplet is 3.14 [pL]. The average value VA of the volumes of the ink droplets from the third shot to the sixth shot is 3.15 [pL]. The ejecting volume ratio R_{D} is R_{D}=VA/V1=0.955.

FIG. 11A and FIG. 11B are simplified illustrations of the plurality of nozzles NZ and the plurality of pixels PX depicted in FIG. 6. Four nozzles NZ1, NZ2, NZ3, and NZ4 are aligned in the medium widthwise direction and are adjacent to each other. The relationship between the driving waveform, the ejected ink droplets, and the pixels in the embodiment will be described below, referring to the simplified situations depicted in FIG. 11A and FIG. 11B as examples.

In a case where the controller 500 continuously forms the pixels PX of the same tone value on the medium PM at the high driving frequency, the controller 500 drives each of the actuators AC1 to AC4 based on the driving signal DS1. In this situation, the controller 500 outputs the driving signal DS1 to each of the first actuator AC1 and the third actuator AC3 so that the increasing driving waveform DW_{I} is applied to the first actuator AC1 and the third actuator AC3 at the first timing, at the third timing after two cycles of the driving cycle have elapsed from the first timing, and at the fifth timing after two cycles of the driving cycle have elapsed from the third timing. In this situation, the controller 500 outputs the driving signal DS1 to each of the first actuator AC1 and the third actuator AC3 so that the decreasing driving waveform DW_{D} is applied to the first actuator AC1 and the third actuator AC3 at the second timing after one cycle of the driving cycle has elapsed from the first timing, at the fourth timing after two cycles of the driving cycle have elapsed from the second timing, and at the sixth timing after two cycles of the driving cycle have elapsed from the fourth timing. For each of the second actuator AC2 and the fourth actuator AC4, the controller 500 outputs the driving signal DS1 so that the decreasing driving waveform DW_{D} is applied to the second actuator AC2 and the fourth actuator AC4 at the first, third, and fifth timings and the increasing driving waveform DW_{I} is applied to the second actuator AC2 and the fourth actuator AC4 at the second, fourth, and sixth timings.

As depicted in FIG. 11A, on the medium PM, the pixel PX formed by the ink droplets ejected by applying of the increasing driving waveform DW_{I} to the actuators AC (indicated by circled “I” in FIG. 11A) and the pixels PX formed by the ink droplets ejected by applying of the decreasing driving waveform DW_{D} to the actuators AC (indicated by circled “D” in FIG. 11B) are arranged in a checkered pattern.

Specifically, in FIG. 11A, pixels PXₘₙ (m=1, 2, 3, 4. n=1, 2, . . . , 6) are the pixels formed by ink ejected from a nozzle NZm at a nth timing, respectively. For example, the pixels PX₁₁, PX₂₁, PX₃₁, and PX₄₁ are pixels formed at the first timing by the ink droplets ejected from the nozzles NZ1, NZ2, NZ3, and NZ4, respectively.

In such a manner, by differentiating the driving waveforms to be applied to the nozzles NZ (actuators AC) adjacent to each other in the medium widthwise direction from each other and differentiating the driving waveform to be applied to the nozzle NZ (the actuator AC) at a timing and the driving waveform to be applied to said nozzle NZ (said actuator AC) at the next timing from each other, the pixels PX formed by the ink droplets ejected according to the increasing driving waveform DW_{I} and the pixels PX formed by the ink droplets ejected according to the decreasing driving waveform DW_{D} are arranged on the medium PM in the checkered pattern. In other words, in both the medium widthwise direction and the conveying direction, the pixels PX formed by the ink droplets ejected according to the increasing driving waveform DW_{I} and the pixels PX formed by the ink droplets ejected according to the decreasing driving waveform DW_{D} are arranged alternately.

The table in FIG. 12A shows the volumes of the ink droplets ejected from the nozzles NZ1 to NZ4 at the first timing to the sixth timing in the above ejecting. As can be read from the table in FIG. 12A, the volumes of the ink droplets ejected by the increasing driving waveform DW_{I} at the third timing or later are smaller than 3.30 [pL]. This is due to the effect of residual vibration caused by the decreasing driving waveform DW_{D} applied at the previous timing (i.e., one cycle before). The volume of the ink droplets ejected by the decreasing driving waveform DW_{D} at the third timing or later are larger than 3.30 [pL]. This is due to the effect of residual vibration caused by the increasing driving waveform DW_{I} applied at the previous timing. The average of the volumes of the ink droplets ejected at the third timing or later is 3.30 [pL].

In a case where the controller 500 continuously forms the pixels PX of the same tone value on the medium PM at a low driving frequency, the controller 500 drives each of the actuators AC1 to AC4 based on the driving signal DS2. In this situation, the controller 500 outputs the driving signal DS2 to each of the first actuator AC1 and the third actuator AC3 so that the increasing driving waveform DW_{I} is applied to the first actuator AC1 and the third actuator AC3 at the first timing, at the third timing after two cycles of the driving cycle have elapsed from the first timing, and at the fifth timing after two cycles of the driving cycle have elapsed from the third timing. In this situation, the controller 500 outputs the driving signal DS2 to each of the first actuator AC1 and the third actuator AC3 so that the decreasing driving waveform DW_{D} is applied to the first actuator AC1 and the third actuator AC3 at the second timing after one cycle of the driving cycle has elapsed from the first timing, at the fourth timing after two cycles of the driving cycle have elapsed from the second timing, and at the sixth timing after two cycles of the driving cycle have elapsed from the fourth timing. For each of the second actuator AC2 and the fourth actuator AC4, the controller 500 outputs the driving signal DS2 so that the decreasing driving waveform DW_{D} is applied to the second actuator AC2 and the fourth actuator AC4 at the first, third, and fifth timings and the increasing driving waveform DW_{I} is applied to the second actuator AC2 and the fourth actuator AC4 at the second, fourth, and sixth timings. The pattern of the pixels PX formed on the medium PM as a result of the above process (FIG. 11B) has a larger spacing between the pixels PX in the conveying direction compared to the pattern in which the pixels PX of the same tone value are continuously formed on the medium PM at the high driving frequency (i.e., the pattern depicted in FIG. 10A).

The table in FIG. 12B shows the volumes of the ink droplets ejected from the nozzles NZ1 to NZ4 at the first timing to the sixth timing in the ejecting described above. As can be read from the table in FIG. 12B, at the third timing or later, the volumes of the ink droplets ejected after one cycle of the timing when the increasing driving waveform DW_{I} is applied and the volumes of the ink droplets ejected after one cycle of the timing when the decreasing driving waveform DW_{D} is applied are all close to 3.30 [pL]. This is because, in a case where the ink droplets are ejected at the low driving frequency, the effect of residual vibration of the actuator AC is small, and the volume of the ink droplet ejected after one cycle of the timing at which the increasing driving waveform DW_{I} is applied and the volume of the ink droplet ejected after one cycle of the timing at which the decreasing driving waveform DW_{D} is applied, are each close to the volume V1 of the ink droplet of the first shot shown in FIG. 10A and FIG. 10B. The average value of the volumes of the ink droplets ejected at the third timing and later is 3.25 [pL].

The reasons for applying the increasing driving waveform DW_{I} and the decreasing driving waveform DW_{D} in the printer 1000, and the advantageous effects obtained by applying the increasing driving waveform DW_{I} and the decreasing driving waveform DW_{D} are as follows.

In a case where the printer 1000 ejects the ink droplets at the low driving frequency (i.e., in a case where the driving cycle is large), the pixels PX formed by the landing of the ink droplets are sparsely located on the medium PM (FIG. 11B). In this situation, if the pixel PX is large, the pixel PX stands out as a grain. In other words, the granular quality of the formed image increases. Therefore, in a case where the printer 1000 ejects the ink droplets at the low driving frequency, making the volume of the ink droplet small enough to suppress the granular quality is desired.

On the other hand, in a case where the printer 1000 ejects the ink droplets at the high driving frequency (i.e., in a case where the driving cycle is small), the pixels PX formed by the landing of the ink droplets are densely located on the medium PM (FIG. 11A). In this situation, if the pixels PX are small, the image formed by the densely located pixels PX will not have sufficient density. Therefore, in a case where the printer 1000 performs the image forming at the high driving frequency, making the volume of the ink droplet large enough for the image to have sufficient density is desired.

Here, the size of the ink droplet for suppressing granular quality and the size of the ink droplet for the image to have sufficient density are equal to each other in the embodiment, and are 3.30 [pL].

However, in the conventional design of driving waveforms, if the driving waveform is designed so that the volume of the ink droplet in ejecting of the ink droplets at the low driving frequency is the optimum value, the volume of the ink droplet in ejecting of the ink droplets at the high driving frequency becomes unsuitable value. On the other hand, if the driving waveform is designed so that the ink droplet volume is the optimal value in ejecting of the ink droplets at the high driving frequency, the volume of the ink droplet in ejecting at the low driving frequency becomes unsuitable value. That is, achieving both suitable volume of the ink droplet in ejecting of the ink droplets at the low driving frequency and suitable volume of the ink droplet in ejecting of the ink droplets at the high driving frequency is difficult. This is even more difficult if the necessity of fulfilling other requirements in driving waveform design (e.g., reducing of ejecting defect such as satellite, mist, and the like; realization of ejecting stability, etc.) were also taken into consideration. Although the volume of the ink droplets can be increased or decreased by increasing or decreasing the driving voltage, in such a case, the volume of the ink droplet in ejecting at the high driving frequency and the volume of ink droplet in ejecting at the low driving frequency both increase or decrease. Therefore, those volumes cannot be adjusted separately.

In contrast, in the embodiment, the ink droplets are ejected by using two different driving waveforms from each other, that is, the increasing driving waveform DW_{I} and the decreasing driving waveform DW_{D}. As a result, the image formed on the medium PM has an intermediate property between the image formed by the ink droplets of relatively large diameter ejected under the influence of the increasing driving waveform DW_{I} and the image formed by the ink droplets of relatively small diameter ejected under the influence of the decreasing driving waveform DW_{D}.

In other words, by using the increasing driving waveform DW_{I} and the decreasing driving waveform DW_{D}, the volume of the ink droplets ejected is substantially intermediate value between the volume of the ink droplet with a relatively large diameter ejected under the influence of the increasing driving waveform DW_{I} and the volume of the ink droplet with a relatively small diameter ejected under the influence of the decreasing driving waveform DW_{D}.

Here, as depicted in FIG. 12A, in ejecting of the ink droplets at the high driving frequency, the volumes of the ink droplets ejected after one cycle of the timing of the application of the increasing driving waveform DW_{I} are larger than the target value of 3.30 [pL], and the volumes of ink droplets ejected after one cycle of the timing of the application of the decreasing driving waveform DW_{D} are smaller than the target value of 3.30 [pL]. However, by using the combination of the increasing driving waveform DW_{I} and the decreasing driving waveform DW_{D}, the average of the volumes of the plurality of ink droplets ejected at the third timing and later is the target value of 3.30 [pL], and the quality of the formed image is equal to the quality achieved in a case where the volume of each ink droplet is the target value of 3.30 [pL].

As depicted in FIG. 12B, in the ejecting of the ink droplets at the low driving frequency, both the volumes of the ink droplets ejected after one cycle of the timing of the application of the increasing driving waveform DW_{I} and the volumes of the ink droplets ejected after one cycle of the timing of the application of the decreasing driving waveform DW_{D} are close to the target value of 3.30 [pL]. Therefore, even with the increasing driving waveform DW_{I} and the decreasing driving waveform DW_{D}, the average value of the volumes of the plurality of ink droplets is 3.25 [pL], which is close to the target value of 3.30 [pL], and the quality of the formed image is almost the same as the quality achieved when the volume of each ink droplet is the target value. Making the average value of the volumes of the plurality of ink droplets equal to the target value of 3.30 [pL] is possible, by setting the low driving frequency to a value lower than 31.5 kHz.

As describe above, in the embodiment, two types of driving waveforms are used in combination so as to make an ejecting volume of the ink droplet an average of the ejecting volumes based on the effect of each of the two types of driving waveforms. As a result, achieving both a suitable volume of the ink droplet in ejecting of the ink droplets at the low driving frequency and a suitable volume of the ink droplet in ejecting of the ink droplets at the high driving frequency, which is difficult to realize based on only one type of driving waveform, is realized.

### Modifications

In the above embodiment, the following modifications can also be used.

In the above embodiment, the controller 500 generates and outputs the driving signal so that the pixels PX formed by the ink droplets ejected by the increasing driving waveform DW_{I} and the pixels PX formed by the ink droplets ejected by the decreasing driving waveform DW_{D} are formed on the medium PM in the checkered pattern. However, there is no limitation thereto.

### Alternate Application of the Increasing Driving Waveform and the Decreasing Driving Waveform Timing by Timing

For each of the ejecting of the ink droplets at the high driving frequency and the ejecting of the ink droplets at the low driving frequency, as depicted in FIG. 13, generating and outputting of the driving signal may be performed so that the pixels PX formed by the ink droplets ejected by the increasing driving waveform DW_{I} and the pixels PX formed by the ink droplets ejected by the decreasing driving waveform DW_{D} are alternately arranged in the conveying direction. In this case, the controller 500 generates and outputs the driving signals so that the increasing driving waveform DW_{I} is applied to each of the actuators AC1 to AC4 in the first, third and fifth timings. Further, in this case, the controller 500 generates and outputs the driving signals so that the decreasing driving waveform DW_{D} is applied to each of the actuators AC1 to AC4 in the second, fourth and sixth timings.

The table in FIG. 14A shows the volumes of the ink droplets ejected from the nozzles NZ1 to NZ4 at the first timing to the sixth timing in a case where the ink droplets are ejected in the above manner at the high driving frequency. As can be read from the table in FIG. 14A, the volume of the ink droplets ejected one cycle after the timing of the application of the increasing driving waveform DW_{I} is larger than 3.30 [pL], and the volumes of the ink droplets ejected one cycle after the timing of the application of the decreasing driving waveform DW_{D} is smaller than 3.30 [pL]. The average value of the volumes of the ink droplets ejected at the third timing and later is 3.30 [pL].

The table in FIG. 14B shows the volumes of the ink droplets ejected from the nozzles NZ1 to NZ4 at the first timing to the sixth timing in a case where the ink droplets are ejected in the above manner at the low driving frequency. As can be read from the table in FIG. 14B, the volumes of the ink droplets ejected by the increasing driving waveform DW_{I} at the third timing and later and the volumes of the ink droplets ejected by the decreasing driving waveform DW_{D} at the third timing and later are all close to 3.30 [pL]. The average value of the volumes of the ink droplets ejected at the third timing and later is 3.25 [pL].

### Alternate Application of the Increasing Driving Waveform and the Decreasing Driving Waveform Nozzle by Nozzle

Regarding each of the ejecting of the ink droplets at the high driving frequency and the ejecting of the ink droplets at the low driving frequency, as depicted in FIG. 15, the controller 500 may generate and output of the driving signal so that the pixels PX formed by the ink droplets ejected by the increasing driving waveform DW_{I} and the pixels PX formed by the ink droplets ejected by the decreasing driving waveform DW_{D} are arranged alternately in the medium widthwise direction. In this case, the controller 500 generates and outputs driving signals so that the increasing driving waveform DW_{I} is applied to the actuators AC1 and AC3 at each of the first timing to the sixth timing and the decreasing driving waveform DW_{D} is applied to the actuators AC2 and AC4 at each of the first timing to the sixth timing.

The table in FIG. 16A shows the volumes of the ink droplets ejected from the nozzles NZ1 to NZ4 at the first timing to the sixth timing in a case where the ejecting of the ink droplets at the high driving frequency is performed in the above manner. As can be read from the table in FIG. 16A, at the second timing and later, the volumes of ink droplets ejected from the nozzles NZ1 and NZ3, to which the increasing driving waveform DW_{I} is continuously applied, are larger than 3.30 [pL], while the volumes of the ink droplets ejected from the nozzles NZ2 and NZ4, to which the decreasing driving waveform DW_{D} is continuously applied, are smaller than 3.30 [pL]. The average of the volumes of the ink droplets ejected at the third timing and later is 3.30 [pL].

The table in FIG. 16B shows the volumes of the ink droplets ejected from the nozzles NZ1 to NZ4 at the first timing to the sixth timings in a case where the ink droplets are ejected at the low driving frequency in the above manner. As can be read from the table in FIG. 16B, the volumes of the ink droplets ejected from the nozzles NZ1 and NZ3, to which the increasing driving waveform DW_{I} is continuously applied, and the volumes of the ink droplets ejected from the nozzles NZ2 and NZ4, to which the decreasing driving waveform DW_{D} is continuously applied, are all close to 3.30 [pL]. The average value of the volumes of the ink droplets ejected at the third timing and later is 3.25 [pL].

### Modifications of the Ejecting Volume Ratio

In the above embodiment and the modifications, regarding the increasing driving waveform DW_{I}, the ejecting volume ratio R_{I} of the average value VA to the volume V1 is 1.045, and regarding the decreasing driving waveform DW_{D}, the ejecting volume ratio R_{D} of the average value VA to the volume V1 is 0.955. Therefore, the arithmetic mean of R_{I} and R_{D} is 1.000. However, there is no limitation thereto. The arithmetic mean of R_{I} and R_{D} may be any value of 0.95 or more and 1.05 or less. This allows the volumes of the ink droplets in the ejecting of the ink droplets at the high driving frequency performed by using the increasing driving waveform DW_{I} and the decreasing driving waveform DW_{D} to more suitably approach the volumes of the ink droplets in the ejecting of the ink droplets at the low driving frequency substantially.

### Combined Usage of Two Types of Increasing Driving Waveforms

In the above embodiment and the modifications, the increasing driving waveform DW_{I}, by which the volume of the ink droplet in ejecting of the ink droplets at the high driving frequency is larger than the volume of the ink droplet in ejecting of the ink droplets at the low driving frequency, and the decreasing driving waveform DW_{D}, by which the volume of the ink droplet in the ejecting of the ink droplets at the high driving frequency is smaller than the volume of the ink droplet in the ejecting of the ink droplets at the low driving frequency, are used in combination. However, there is no limitation thereto.

In the above embodiment and the modifications, the decreasing driving waveform DW_{D} may be replaced with an increasing driving waveform DW_{I1}, which causes a larger volume increasing of the ink droplet as compared to the increasing driving waveform DW_{I}.

The increasing driving waveform DW_{I1} is a driving waveform configured so that volumes of the ink droplets ejected second and later are larger than a volume of the ink droplet ejected first in a case where the ink droplets are ejected from the nozzle NZ at the high driving frequency (63 kHz as an example) based on the increasing driving waveform DW_{I1}.

The increasing driving waveform DW_{I1} consists of two pulses like the increasing driving waveform DW_{I}. The increasing driving waveform DW_{I1} is different from the increasing driving waveform DW_{I} only in that a pulse width and a width of an interval between the pulses. The pulse width of a first pulse in the increasing driving waveform DW_{I1} is 5.0 [μs] and the pulse width of a second pulse in the increasing driving waveform DW_{I1} is 2.6 [μs]. There is an interval of 2.6 [μs] between the first pulse and the second pulse. During the risen period of the first pulse and the risen period of the second pulse, the driving voltage of 100% is applied to the actuator AC.

The case where the increasing driving waveform DW_{I1} is applied to the actuator AC with a cycle of about 16 [μs] corresponding to the high driving frequency (63 kHz) to eject the ink droplets from the nozzle NZ corresponding to the actuator AC is considered. In this situation, as depicted in FIG. 17, the volumes of the second and subsequent ink droplets are larger than the volume of the first ink droplet. Specifically, the volume V1 of the first ink droplet is 3.30 [pL], the volume V2 of the second ink droplet is 3.69 [pL], the volume V3 of the third ink droplet is 3.58 [pL], the volume V4 of the fourth ink droplet is 3.64 [pL], the volume V5 of the fifth ink droplet is 3.62 [pL], and the volume V6 of the sixth ink droplet is 3.61 [pL]. The average value VA of the volumes of the ink droplets of the third shot to the sixth shot is 3.61 [pL]. The ratio of the average value VA to the volume V1, that is, the ejecting volume ratio R_{I1}, is R_{I1}=VA/V1=1.095.

FIG. 18 depicts the pixels PX formed on the medium PM by performing the ejecting in the manner same as the manner in the above embodiment while replacing the decreasing driving waveform DW_{D} with the increasing driving waveform DW_{I1}. On the medium PM, the pixels PX formed by the ink droplets ejected by applying the increasing driving waveform DW_{I}to the actuator AC (indicated by circled “I” in FIG. 18) and the pixels PX formed by the ink droplets ejected by applying the increasing driving waveform DW_{I1} to the actuator AC (indicated by circled “I1” in FIG. 18) are arranged in the checkered pattern.

The table in FIG. 19 shows the volumes of the ink droplets ejected from the nozzles NZ1 to NZ4 at the first timing to the sixth timing in the above ejecting. As can be read from the table in FIG. 19, the volume of the ink droplet ejected one cycle after the timing of application of the increasing driving waveform DW_{I1} is larger than the volume of the ink droplet ejected one cycle after the timing of application of the increasing driving waveform DW_{I}. In this modification, the volume increasing of the ink droplet affected by the increasing driving waveform DW_{I} is combined with the volume increasing of the ink droplet affected by the increasing driving waveform DW_{I1} so that the average of the volumes of the ink droplets ejected at the third timing and later is 3.53 [pL], which is the target value in this modification.

Designing a driving waveform that makes a volume of the ink droplet in the ejecting of the ink droplets at the low driving frequency a target value (e.g., 3.30 [pL]), and further adjusting said driving waveform so that the volume of the ink droplet in the ejecting of the ink droplets at the high driving frequency becomes a target value (3.53 [pL] in this modification) is difficult in general. However, by combining two different driving waveforms by each of which the volume of the ink droplet in the ejecting of the ink droplets at the high driving frequency is larger than the volume of the ink droplet in the ejecting of the ink droplets at the low driving frequency, the volume of the ink droplet in the ejecting of the ink droplets at the high driving frequency can be made closer to the target value substantially.

### Combined Usage of Two Types of Decreasing Driving Waveforms

In the above embodiment and the modifications, the increasing driving waveform DW_{I} may be replaced with a decreasing driving waveform DW_{D1}, which causes larger decrease in ejecting volume as compared to the decreasing driving waveform DW_{D}.

The decreasing driving waveform DW_{DI} is a driving waveform configured so that volumes of the ink droplets ejected second and later are smaller than a volume of the ink droplet ejected first in a case where the ink droplets are ejected from the nozzle NZ at the high driving frequency (63 kHz as an example) based on the decreasing driving waveform DW_{D1}.

The decreasing driving waveform DW_{DI} consists of two pulses like the decreasing driving waveform DW_{D}. The decreasing driving waveform DW_{DI} is different from the decreasing driving waveform DW_{D} only in that a pulse width and a width of an interval between the pulses. The pulse width of a first pulse in the decreasing driving waveform DW_{DI} is 5.0 [μs] and the pulse width of a second pulse in the decreasing driving waveform DW_{DI} is 0.8 [μs]. There is an interval of 1.9 [μs] between the first pulse and the second pulse. During the risen period of the first pulse and the risen period of the second pulse, the driving voltage of 100% is applied to the actuator AC.

The case where the decreasing driving waveform DW_{DI} is applied to the actuator AC with a cycle of about 16 [μs] corresponding to the high driving frequency (63 kHz) to eject the ink droplets from the nozzle NZ corresponding to the actuator AC is considered. In this situation, as depicted in FIG. 20, the volumes of the second and subsequent ink droplets are smaller than the volume of a first ink droplet. Specifically, the volume V1 of the first ink droplet is 3.30 [pL], the volume V2 of the second ink droplet is 2.98 [pL], the volume V3 of the third ink droplet is 2.99 [pL], the volume V4 of the fourth ink droplet is 3.04 [pL], the volume V5 of the fifth ink droplet is 3.03 [pL], and the volume V6 of the sixth ink droplet is 3.01 [pL]. The average value VA of the volumes of the ink droplets of the third shot to the sixth shot is 3.02 [pL]. The ratio of the average value VA to the volume V1, that is, the ejecting volume ratio R_{D1}, is R_{D1}=VA/V1=0.914.

FIG. 21 depicts the pixels PX formed on the medium PM by performing the ejecting in the manner same as the manner in the above embodiment while replacing the increasing driving waveform DW_{I} with the decreasing driving waveform DW_{D1}. On the medium PM, the pixels PX formed by the ink droplets ejected by applying the decreasing driving waveform DW_{D} to the actuator AC (indicated by circled “D” in FIG. 21) and the pixels PX formed by the ink droplets ejected by applying the decreasing driving waveform DW_{DI} to the actuator AC (indicated by circled “D1” in FIG. 21) are arranged in the checkered pattern.

The table in FIG. 22 shows the volumes of the ink droplets ejected from the nozzles NZ1 to NZ4 at the first timing to the sixth timing in the above ejecting. As can be read from the table in FIG. 22, the volume of the ink droplet ejected one cycle after the timing of application of the decreasing driving waveform DW_{D1} is smaller than the volume of the ink droplet ejected one cycle after the timing of application of the decreasing driving waveform DW_{D}. In this modification, the volume decreasing of the ink droplet affected by the decreasing driving waveform DW_{D} is combined with the volume decreasing of the ink droplet affected by the decreasing driving waveform DW_{DI} so that the average of the volumes of the ink droplets ejected at the third timing and later is 3.08 [pL], which is the target value in this modification.

Designing a driving waveform that makes a volume of the ink droplet in the ejecting of the ink droplets at the low driving frequency a target value (e.g., 3.30 [pL]), and further adjusting said driving waveform so that the volume of the ink droplet in the ejecting of the ink droplets at the high driving frequency becomes a target value (3.08 [pL] in this modification) is difficult, in general. However, by combining two different driving waveforms by each of which the volume of the ink droplet in the ejecting of the ink droplets at the high driving frequency is smaller than the volume of the ink droplet in the ejecting of the ink droplets at the low driving frequency, the volume of the ink droplet in the ejecting of the ink droplets at the high driving frequency can be substantially made closer to the target value.

### Combined Usage of Three or More Driving Waveforms

In the above embodiment and the modifications, two types of driving waveforms are used in combination. However, there is no limitation thereto. The printer 1000 can use two or more types of driving waveforms in combination.

Specifically, for example, the printer 1000 may use the decreasing driving waveform DW_{D}, an increasing driving waveform DW_{I2}, and an increasing driving waveform DW_{I3} in combination.

Each of the increasing driving waveform DW_{I2} and the increasing driving waveform DW_{I3} is a driving waveform configured so that volumes of the ink droplets ejected second and later are larger than a volume of the ink droplet ejected first in a case where the ink droplets are ejected from the nozzle NZ at the high driving frequency (63 kHz as an example) based on each of the increasing driving waveform DW_{I2} and the increasing driving waveform DW_{I3}.

The increasing driving waveform DW_{I2} consists of two pulses like the increasing driving waveform DW_{I}. The increasing driving waveform DW_{I2} is different from the increasing driving waveform DW_{I} only in that a pulse width and a width of an interval between the pulses. The pulse width of a first pulse in the increasing driving waveform DW_{I2} is 5.0 [μs] and the pulse width of a second pulse in the increasing driving waveform DW_{I2} is 2.6 [μs]. There is an interval of 1.6 [μs] between the first pulse and the second pulse. The increasing driving waveform DW_{I3} consists of two pulses like the increasing driving waveform DW_{I}. The increasing driving waveform DW_{I3} is different from the increasing driving waveform DW_{I} only in that a pulse width and a width of an interval between the pulses. The pulse width of a first pulse in the increasing driving waveform DW_{I3} is 5.0 [μs] and the pulse width of a second pulse in the increasing driving waveform DW_{I3} is 1.9 [μs]. There is an interval of 2.2 [μs] between the first pulse and the second pulse. In each of the increasing driving waveforms DW_{I2} and DW_{I3}, the driving voltage of 100% is applied to the actuator AC during the risen period of the first pulse and the risen period of the second pulse.

The case where the increasing driving waveform DW_{I2} is applied to the actuator AC with a cycle of about 16 [μs] corresponding to the high driving frequency (63 kHz) to eject the ink droplets from the nozzle NZ corresponding to the actuator AC is considered. In this situation, as depicted in FIG. 23A, the volumes of the second and subsequent ink droplets are larger than the volume of the first ink droplet. Specifically, the volume V1 of the first ink droplet is 3.30 [pL], the volume V2 of the second ink droplet is 3.37 [pL], the volume V3 of the third ink droplet is 3.32 [pL], the volume V4 of the fourth ink droplet is 3.38 [pL], the volume V5 of the fifth ink droplet is 3.36 [pL], and the volume V6 of the sixth ink droplet is 3.34 [pL]. The average value VA of the volumes of the ink droplets of the third shot to the sixth shot is 3.35 [pL]. The ratio of the average value VA to the volume V1, that is, the ejecting volume ratio R_{I2}, is R_{I2}=VA/V1=1.015.

The case where the increasing driving waveform DW_{I3} is applied to the actuator AC with a cycle of about 16 [μs] corresponding to the high driving frequency (63 kHz) to eject the ink droplets from the nozzle NZ corresponding to the actuator AC is considered. In this situation, as depicted in FIG. 23B, the volumes of the second and subsequent ink droplets are larger than the volume of the first ink droplet. Specifically, the volume V1 of the first ink droplet is 3.30 [pL], the volume V2 of the second ink droplet is 3.40 [pL], the volume V3 of the third ink droplet is 3.35 [pL], the volume V4 of the fourth ink droplet is 3.41 [pL], the volume V5 of the fifth ink droplet is 3.39 [pL], and the volume V6 of the sixth ink droplet is 3.38 [pL]. The average value VA of the volumes of the ink droplets of the third shot to the sixth shot is 3.38 [pL]. The ratio of the average value VA to the volume V1, that is, the ejecting volume ratio R_{I3}, is R_{I3}=VA/V1=1.025.

FIG. 24 depicts the pixels PX formed on the medium PM by applying the increasing driving waveform DW_{I3} to each of the actuator AC1 to the actuator AC4 at the first timing and the fourth timing, applying the increasing driving waveform DW_{I2} to each of the actuator AC1 to the actuator AC4 at the second timing and the fifth timing, and applying the decreasing driving waveform DW_{D} to each of the actuator AC1 to the actuator AC4 at the third timing and the sixth timing. On the medium PM, the pixels PX formed by the ink droplets ejected by applying the increasing driving waveform DW_{I3} to the actuators AC (indicated by circled “I3” in FIG. 24) and the pixels PX formed by the ink droplets ejected by applying the increasing driving waveform DW_{I2} to the actuators AC (indicated by circled “I2” in FIG. 24) and the pixels PX formed by the ink droplets ejected by applying the decreasing driving waveform DW_{D} to the actuators AC (indicated by circled “D” in FIG. 24) are periodically arranged along the conveying direction.

By using three or more types of driving waveforms in combination as described above, the substantial volume of the ink droplet in the ejecting of the ink droplets at the high driving frequency can be made closer to the target value more suitably. As a way of combining the three types of driving waveforms, for example, at all timings, the increasing driving waveform DW_{I3} is applied to the (3n−2)th nozzle NZ from one side in the medium widthwise direction, the increasing driving waveform DW_{I2} may be applied to the (3n−1)th nozzle NZ from the one side in the medium widthwise direction, and the decreasing driving waveform DW_{D} may be applied to the 3nth nozzle NZ from the one side in the medium widthwise direction. Here, n is an integer being equal to or greater than one.

### Other Modifications

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

An aspect in which the plurality of driving waveforms is used in combination is not limited to the aspects described in the above embodiment and the modifications. The aspect may be any aspect in which the controller 500 applies a first driving waveform to a first actuator AC at a first timing and applies a second driving waveform different from the first driving waveform to the first actuator AC at a second timing after one cycle of a driving frequency has elapsed from the first timing, and/or the controller 500 applies the first driving waveform to the first actuator AC at the first timing and applies the second driving waveform to the second actuator AC adjacent to the first actuator AC at the first timing.

Specifically, for example, the controller 500 may generate driving waveforms so that at all timings, the increasing driving waveform DW_{I} is applied to the (3n−2)th and (3n−1)th nozzle NZ from one side in the medium widthwise direction and the decreasing driving waveform DW_{D} is applied to the 3nth nozzle NZ from the one side in the medium widthwise direction. Alternatively, the controller 500 may generate a driving waveform so that the increasing driving waveform DW_{I} is applied to the nozzle NZ at the (3n−2)th and (3n−1)th timings and the decreasing driving waveform DW_{D} is applied to the nozzle NZ at the 3nth timing. Here, n is an integer being equal to or greater than one.

In the above embodiment and the modifications, the description is simplified to four nozzles and six timings. In actual printing, however, the ejecting is performed at many timings using many nozzles. In this case, the pattern described in any one of the above embodiment and modifications may be repeated to perform the ejecting at all nozzles and at all timings. Alternatively, a combination of the plurality of patterns described in the above embodiment and modifications may be used to perform the ejecting at all nozzles and at all timings.

In the above embodiment and the modifications, the medium PM moves with respect to the fixed head system 100. However, there is no limitation thereto. The head such as the head system 100 and the like may move with respect to the fixed medium PM. The feature of “forming an image on a medium by ejecting a liquid from a head in a state that one of the head and the medium is moved in a moving direction relative to other of the head and the medium” includes both the aspect in which movement of the head and/or medium and the ejecting of the liquid are performed simultaneously (i.e., the movement and the ejecting are performed simultaneously) and the aspect in which movement of the head and/or medium and the ejecting of the liquid are performed alternately (i.e., the movement and the ejecting are performed alternately, and no ejecting performed during the movement and no movement performed during the ejecting).

Each of the increasing driving waveforms DW_{I}, DW_{I1}, DW_{I2}, DW_{I3}, and the decreasing driving waveforms DW_{D} and DW_{D1} of the above embodiment and the modifications are examples of a “first driving waveform” and a “second driving waveform”.

The fact that the ejecting volume of the third shot is different from the ejecting volume of the first shot in a case where each of the increasing driving waveforms DW_{I}, DW_{I1}, DW_{I2}, DW_{I3}, and the decreasing driving waveforms DW_{D}, DW_{D1} is continuously applied to the actuator AC at a driving frequency of 63 kHz is an example of a feature of “a first driving waveform is configured so that, in a case where the first driving waveform is continuously applied to an actuator at a driving frequency, an ejecting volume of a droplet ejected thirdly from a nozzle is R₁ times of an ejecting volume of a droplet ejected firstly from the nozzle” and a feature of “a second driving waveform is configured so that, in a case where the second driving waveform is continuously applied to an actuator at a driving frequency, an ejecting volume of a droplet ejected thirdly from the nozzle is R₂ times of an ejecting volume of a droplet ejected firstly from the nozzle”. As can be read from the description of the embodiment and the modifications, the volume (ejecting volume) of the ink droplet (droplet) ejected is a value corresponding to the shape of the driving waveform applied one cycle earlier, and thus in a case where a certain driving waveform is continuously applied to an actuator at a predetermined driving frequency, the ejecting volumes of the droplets of the third shot and later are identical or nearly identical to each other. Therefore, each of the increasing driving waveforms DW_{I}, DW_{I1}, DW_{I2}, DW_{I3}, and the decreasing driving waveforms DW_{D}, DW_{D1}, is an example of the driving waveform satisfying the feature of “a first driving waveform is configured so that, in a case where the first driving waveform is continuously applied to an actuator at a driving frequency, an ejecting volume of each of droplets ejected thirdly and later from a nozzle is substantially R₁ times of an ejecting volume of a droplet ejected firstly from the nozzle”, and the feature of “a second driving waveform is configured so that, in a case where the second driving waveform is continuously applied to an actuator at a driving frequency, an ejecting volume of each of droplets ejected thirdly and later from a nozzle is substantially R₂ times of an ejecting volume of a droplet ejected firstly from the nozzle”. Here, “ejected thirdly or later” may mean, for example, the third shot (i.e., the ink droplet ejected thirdly) and later, from the tenth shot (i.e., the ink droplet ejected tenthly) to the hundredth shot (i.e., the ink droplet ejected hundredthly). The substantially R₁ times may be (0.95×R₁) times or more and (1.05×R₁) times or less, and the substantially R₂ times may be (0.95×R₂) times or more and (1.05×R₂) times or less.

The type of the driving waveforms used in combination in the present disclosure is not limited. That is, in the present disclosure, any plural number of driving waveforms may be selected from driving waveform(s) of which ejecting volume ratio R is larger than one and driving waveform(s) of which ejecting volume ratio R is smaller than one, and may be used in combination.

In the above embodiment and the modifications, the high driving frequency is 63kHz and the low driving frequency is 31.5 kHz. However, there is no limitation thereto. Each of the high driving frequency and the low driving frequency may be any value.

In the above embodiment and the modifications, the description is made referring to the printer 100 of the line-head type as an example. However, there is no limitation thereto. The method of the above embodiment and the modifications may be performed in printers of a serial head type. In this case, a scanning direction in which the head moves during printing is an example of the “moving direction”, and the conveying direction in which a medium such as paper is conveyed is an example of the “orthogonal direction”.

In the above embodiment and the modifications, the image forming system is a printer that ejects ink. However, there is no limitation thereto. The image forming system may be any system that ejects a liquid to form an image. The liquid is not limited to ink, but can be any liquid used for image forming. The medium PM on which the image is formed may be, for example, paper, cloth, resin, etc.

The embodiment described herein should be considered exemplary in all respects and not limiting. For example, the number, configuration, etc. of the head system 100, the number, configuration, etc. of the heads 20, the number, configuration, etc. of the actuators AC in the printer 1000 may be changed. The number of colors that the printer 1000 can print simultaneously is also not limited, and the printer 1000 may be configured so that the printer 1000 can perform single color printing only. The number, arrangement, etc. of the individual channel ICH can also be changed as appropriate. The technical features described in each of the embodiment and the modifications can be combined with each other.

As long as the features of the disclosure are maintained, the disclosure is not limited to the above embodiment, and other forms that can be considered within the scope of the technical concept of the disclosure are also included within the scope of the disclosure.

What is claimed is:

1. An image forming method executed by an image forming system,
the image forming system including:
a head having a nozzle and an actuator configured to cause the nozzle to eject a liquid; and
a controller configured to control driving of the head, wherein:
the image forming system is configured to form an image on a medium by ejecting the liquid from the head in a state that one of the head and the medium is moved in a moving direction relative to other of the head and the medium;
the nozzle includes a first nozzle and a second nozzle adjacent to each other in an orthogonal direction orthogonal to the moving direction; and
the actuator includes a first actuator configured to cause the first nozzle to eject the liquid and a second actuator configured to cause the second nozzle to eject the liquid,
the method comprising:
forming a plurality of pixels having tone values same as each other on the medium by continuously applying a first driving waveform and/or a second driving waveform to each of the first actuator and the second actuator at a driving frequency by the controller; and
in the forming of the plurality of pixels, applying the first driving waveform to the first actuator at the first timing and applying the second driving waveform to the first actuator at a second timing after one cycle of the driving frequency from the first timing by the controller, and/or applying the first driving waveform to the first actuator at the first timing and applying the second driving waveform to the second actuator at the first timing, wherein:
the first driving waveform is configured so that, in a case where the first driving waveform is continuously applied to the actuator at the driving frequency, an ejecting volume of a droplet ejected thirdly from the nozzle is R₁ times of an ejecting volume of a droplet ejected firstly from the nozzle;
the second driving waveform is configured so that, in a case where the second driving waveform is continuously applied to the actuator at the driving frequency, an ejecting volume of a droplet ejected thirdly from the nozzle is R₂ times of an ejecting volume of a droplet ejected firstly from the nozzle; and
R₁ and R₂ are different values from each other.

2. The image forming method according to claim 1, wherein one of R₁ and R₂ is larger than 1, and other of R₁ and R₂ is smaller than 1.

3. The image forming method according to claim 1, wherein both of R₁ and R₂ are larger than 1.

4. The image forming method according to claim 1, wherein an arithmetic mean of R₁ and R₂ is 0.95 or more and 1.05 or less.

5. The image forming method according to claim 1, wherein in the forming of the plurality of pixels:
the first driving waveform is applied to each of the first actuator and the second actuator at the first timing by the controller; and
the second driving waveform is applied to each of the first actuator and the second actuator at the second timing by the controller.

6. The image forming method according to claim 1, wherein in the forming of the plurality of pixels, the first driving waveform is applied to the first actuator and the second driving waveform is applied to the second actuator at each of the first timing and the second timing by the controller.

7. The image forming method according to claim 1, wherein in the forming of the plurality of pixels:
the first driving waveform is applied to the first actuator and the second driving waveform is applied to the second actuator at the first timing by the controller; and
the second driving waveform is applied to the first actuator and the first driving waveform is applied to the second actuator at the second timing by the controller.

8. The image forming method according to claim 1, wherein in the forming of the plurality of pixels:
the first driving waveform is applied to the first actuator at the first timing by the controller;
the second driving waveform is applied to the first actuator at the second timing by the controller; and
the first driving waveform is applied to the first actuator at a third timing after one cycle of the driving frequency from the second timing, by the controller.

9. The image forming method according to claim 1, wherein:
the nozzle includes a third nozzle adjacent to the second nozzle at a position opposite to the first nozzle with respect to the second nozzle in the orthogonal direction;
the actuator includes a third actuator configured to cause the third nozzle to eject the liquid; and
in the forming of the plurality of pixels, the first driving waveform is applied to the first actuator, the second driving waveform is applied to the second actuator, and the first driving waveform is applied to the third actuator, at the first timing, by the controller.

10. An image forming system comprising:
a head having a nozzle and an actuator configured to cause the nozzle to eject a liquid; and
a controller configured to control driving of the head, wherein:
the image forming system is configured to form an image on a medium by ejecting the liquid from the head in a state that one of the head and the medium is moved in a moving direction relative to other of the head and the medium;
the nozzle includes a first nozzle and a second nozzle adjacent to each other in an orthogonal direction orthogonal to the moving direction;
the actuator includes a first actuator configured to cause the first nozzle to eject the liquid and a second actuator configured to cause the second nozzle to eject the liquid;
the controller is configured to execute:
forming a plurality of pixels having tone values same as each other on the medium by continuously applying a first driving waveform and/or a second driving waveform to each of the first actuator and the second actuator at a driving frequency; and
in the forming of the plurality of pixels, applying the first driving waveform to the first actuator at the first timing and applying the second driving waveform to the first actuator at a second timing after one cycle of the driving frequency from the first timing, and/or applying the first driving waveform to the first actuator at the first timing and applying the second driving waveform to the second actuator at the first timing;
the first driving waveform is configured so that, in a case where the first driving waveform is continuously applied to the actuator at the driving frequency, an ejecting volume of a droplet ejected thirdly from the nozzle is R₁ times of an ejecting volume of a droplet ejected firstly from the nozzle;
the second driving waveform is configured so that, in a case where the second driving waveform is continuously applied to the actuator at the driving frequency, an ejecting volume of a droplet ejected thirdly from the nozzle is R₂ times of an ejecting volume of a droplet ejected firstly from the nozzle; and
R₁ and R₂ are different values from each other.
